(19) United States
(12) Patent Application Publication
(10) Pub. No.: US 2003/0163544 A1
(43) Pub. Date: Aug. 28, 2003

(54) Remote service systems management interface

(76) Inventors: Michael J. Wookey, Santa Clara, CA (US); Trevor Watson, Sheffield (GB); Jean Chouanard, Redwood City, CA (US)

Correspondence Address: Stephen A. Terrile, HAMILTON & TERRILE, LLP, PO Box 203518, Austin, TX, 78759, US

(21) Appl. No.: 10/067,040

(22) Filed: Feb. 4, 2002

(51) Int. Cl. G06F 15/16

(52) U.S. Cl. 709/217

(57) ABSTRACT

The invention relates to an interfacing between a systems management system and a remote services system which includes: a system management application program interface, a systems management system, and a systems management integrator. The systems management application program interface collects and detects information from the systems management system using a systems management integrator. The systems management integrator interfaces with the systems management system via the systems management application program interface. The systems management system provides and receives information for the remote services system and provides and receives information from a systems management integrator application program interface. The systems management integrator application program interface provides a normalization point where data from the systems management system is normalized to a remote services system standard.

### CROSS REFERENCE TO RELATED APPLICATIONS

This application relates to co-pending U.S. patent application Ser. No. ______, attorney docket number P7225, filed on a even date herewith, entitled “Remote Services Message System to Support Redundancy of Data Flow” and naming Michael J. Wookey, Trevor Watson and Jean Chouanard as inventors, the application being incorporated herein by reference in its entirety.

This application relates to co-pending U.S. patent application Ser. No. ______, attorney docket number P7229, filed on a even date herewith, entitled “Remote Services Delivery Architecture” and naming Michael J. Wookey, Trevor Watson and Jean Chouanard as inventors, the application being incorporated herein by reference in its entirety.

This application relates to co-pending U.S. patent application Ser. No. ______, attorney docket number P7230, filed on a even date herewith, entitled “Prioritization of Remote Services Messages Within a Low Bandwidth Environment” and naming Michael J. Wookey, Trevor Watson and Jean Chouanard as inventors, the application being incorporated herein by reference in its entirety.

This application relates to co-pending U.S. patent application Ser. No. ______, attorney docket number P7231, filed on a even date herewith, entitled “Remote Services System Back-Channel Multicasting” and naming Michael J. Wookey, Trevor Watson and Jean Chouanard as inventors, the application being incorporated herein by reference in its entirety.

This application relates to co-pending U.S. patent application Ser. No. ______, attorney docket number P7233, filed on a even date herewith, entitled “Remote Services System Data Delivery Mechanism” and naming Michael J. Wookey, Trevor Watson and Jean Chouanard as inventors, the application being incorporated herein by reference in its entirety.

This application relates to co-pending U.S. patent application Ser. No. ______, attorney docket number P7234, filed on a even date herewith, entitled “Remote Services WAN Connection Identity Anti-spoofing Control” and naming Michael J. Wookey, Trevor Watson and Jean Chouanard as inventors, the application being incorporated herein by reference in its entirety.

This application relates to co-pending U.S. patent application Ser. No. ______, attorney docket number P7235, filed on a even date herewith, entitled “Automatic Communication Security Reconfiguration for Remote Services” and naming Michael J. Wookey, Trevor Watson and Jean Chouanard as inventors, the application being incorporated herein by reference in its entirety.

### FIELD OF THE INVENTION

The present invention relates to remote service delivery for computer networks, and more particularly, to a systems management interface for use with a remote service delivery system.

### BACKGROUND OF THE INVENTION

It is known to provide a variety of services that are delivered remotely to a customer. These services range from point solutions delivering specific service to more complex remote service instantiations supporting multiple services. The technology behind these services has a number of things in common: they are generally a good idea; they provide a valuable service to a set of customers; and, they are generally isolated from one another.

The number of remote services available show the need and demand for such services. However, the fragmentation of the services reduces the overall benefit to the service provider as well as to the customer. The customer is presented with an often confusing issue of which services to use, why the services are different and why the service provider cannot provide a single integrated service.

One of the challenges when building a system capable of providing remote service is instrumentation and the varying standards that exist for the instrumentation. There are many different systems that control the instrumentation. Many attempts have been made and continue to be made to standardize system management.

A remote service application, however, has the problem that it must not only support computer hardware that runs the latest software, but the system should also provide support for the existing set of instrumentation and systems management that are deployed in the field.

Generally, remote service applications choose a system management system or develop their own. This may cause problems around continued maintenance or full product support coverage.

### SUMMARY OF THE INVENTION

The present invention provides a method for all systems management systems, be they two, three or more tier, to interface with a remote services system via a systems management integrator application program interface (API). Such an API allows a user to utilize many different systems management systems while standardizing the data format within the remote service system for further processing.

In one embodiment, the invention relates to an interfacing between a systems management system and a remote services system which includes: a system management application program interface, a systems management system, and a systems management integrator. The systems management application program interface collects and detects information from the systems management system using a systems management integrator. The systems management integrator interfaces with the systems management system via the systems management application program interface. The systems management system provides and receives information for the remote services system and provides and receives information from a systems management integrator application program interface. The systems management integrator application program interface provides a normalization point where data from the systems management system is normalized to a remote services system standard.

In another embodiment, the invention relates to an apparatus for interfacing between a systems management system and a remote services system which includes: a systems management application program interface and a systems management integrator. The systems management integrator application program interface provides a normalization point where data from the systems management system is normalized to a remote services system standard. An integrator is coupled between the systems management application program interface and the systems management integrator application program interface whereby the integrator collects and detects information from the systems management system.

In another embodiment, the invention relates to a systems management integrator application program interface for a remote services system which includes a forward calls component and a back-channel calls component. The forward calls component provides forwards calls from a systems management system to the remote services system. The back-channel calls component provides back-channel calls from the remote services system to the system management system.

### BRIEF DESCRIPTION OF THE DRAWINGS

The present invention may be understood, and its numerous objects, features, and advantages made apparent to those skilled in the art by referencing the accompanying drawings.

FIG. 1 shows a block diagram of a remote service delivery architecture.

FIG. 2 shows a schematic block diagram of the components relating to the remote services infrastructure.

FIG. 3 shows a publish and subscribe example using the remote services delivery architecture.

FIG. 4 shows a block diagram of the application program interfaces (API's) of the remote service delivery architecture.

FIGS. 5A and 5B show a more detailed version of the components of FIG. 2.

FIG. 6 shows a block diagram of a remote services proxy and a remote services system management integrator.

FIG. 7 shows a block diagram of a remoter services intermediate mid level manager (MLM).

FIG. 8 shows a block diagram of a remote services applications MLM.

FIG. 9 shows a block diagram of an application server module.

FIG. 10 shows a block diagram of a content generation MLM module.

FIG. 11 shows a flow diagram of a remote services system communication.

FIG. 12 shows a block diagram of the data blocks that comprise the data that flows through the remote services infrastructure.

FIGS. 13A and 13B show an example of the high level architecture component relationships of a remote services system that is configured according to the remote services architecture.

FIG. 14 shows a block diagram of a remote services proxy.

FIG. 15 shows a block diagram of the communications between a system management platform and a remote services proxy.

### DETAILED DESCRIPTION

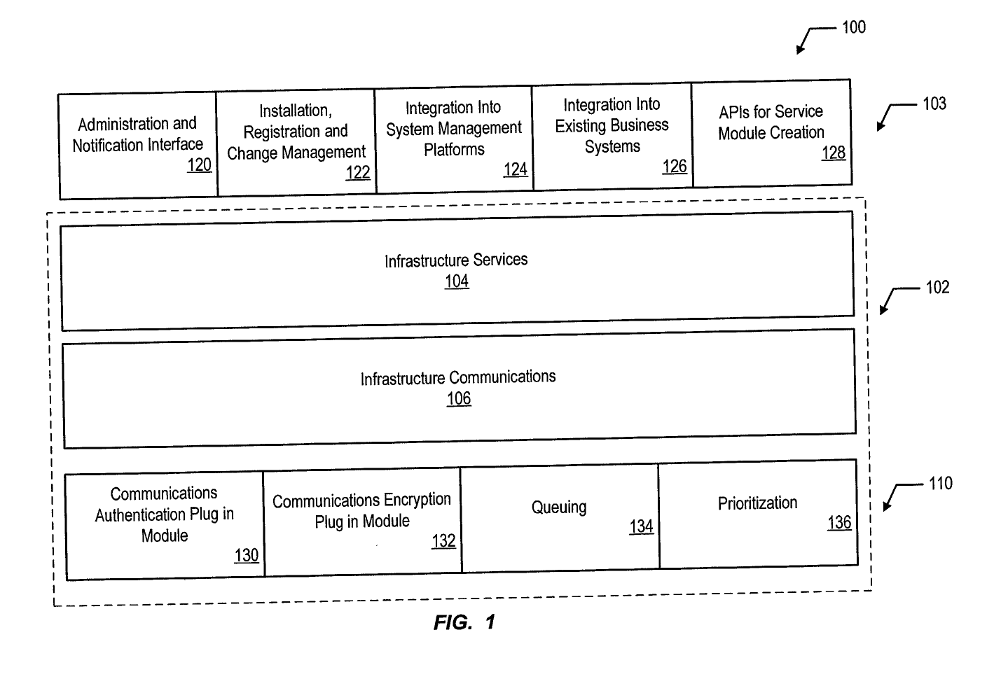

FIG. 1 shows a block diagram of an architecture for a remote service delivery system 100 that meets the needs of both the service provider and the customer. The architecture of the present invention is modularized to provide broad support for both the customer and the service provider in terms of evolution of service functionality to the architecture and within the architecture.

The architecture is broadly comprised of the remote service infrastructure 102, a group of service modules 103 and a plurality of communications modules 110. The remote services infrastructure 102 provides reliable remote service delivery and data management. The remote services infrastructure 102 supports the needs of a service creator by focusing the service creator on the needs and the design of the service by eliminating the need for the service creator to be concerned about how data is transferred and managed to and from a customer site.

The remote services infrastructure 102 provides an interface to support the development of services that use a set of common service parameters to develop customized services for a specific service provider or customer. The infrastructure 102 is separately segmented from, but actively interacts with, the service modules 103.

Within the group of software modules 103 are individual software modules that analyze data collected by the remote services infrastructure 102 and provides service value based on that data to a customer. Thus, the remote services infrastructure 102 and the service modules 103 can be differentiated as follows: the remote services infrastructure 102 is concerned with how data is collected, while the service module 103 is concerned with what is done with the data.

The remote services infrastructure 102 includes an infrastructure services portion 104 and an infrastructure communications portion 106. The infrastructure services portion 104 interacts with the plurality of service modules 103, as described in greater detail below. The remote services infrastructure 102 provides a set of application program interfaces (API's) that are used by a service module developer to leverage common services of the infrastructure such as database access, software delivery and notification services. The infrastructure communications portion 106 includes a plurality of communications modules 110.

The infrastructure services portion 104 interacts with a plurality of service modules 103. Examples of service modules that the remote services architecture may include are an administration and notification interface module 120, an installation, registration and change management module 122, an integration into system management platforms module 124, an integration into existing business systems module 126 and an API's for service module creation module 128. The administration and notification interface 120 allows a customer and service provider to control the remote services infrastructure. The installation, registration and change management module 122 supports the infrastructure and service modules deployed on top of the infrastructure. The module 122 may include automatic registration of new software components, delivery of software and detection of changes within an environment. The integration into systems management platforms module 124 provides an integration point to systems management platforms in general. The integration into existing business systems module 126 allows the remote services infrastructure 102 to integrate into existing business systems to leverage data, processing capacities, knowledge and operational process. The module 126 allows the infrastructure 102 to integrate into the required business systems and provides interfaces to the service module creator to use those systems. The API's for service module creation module 128 allows a service module creator to abstract the complexity of remote data management. The module 128 provides an API of abstracted services to the service module creator.

The infrastructure communications portion 106 provides an abstraction of different protocol and physical network options. Examples of protocol options include an HTTP protocol and an email protocol. Examples of physical network options include Internet based communications, private network based communications and fax communications. The different protocol and physical network options are provided to meet the needs of as many customers as possible.

The infrastructure communications portion 106 supports a number of plug-in communications modules 110. Examples of the communications modules 110 include a communications authentication module 130, an encryption module 132, a queuing module 134, and a prioritization module 136. The communications authentication module 130 is related to the communications protocol that is used and provides the customer with authentication of a communication session. The encryption module 132 is related to the protocol being used and provides encryption of the data stream. The queuing module 134 provides the ability of the infrastructure to queue data being sent through the infrastructure to provide data communications integrity. The prioritization module 136 provides the ability for data within the system to be prioritized for delivery.

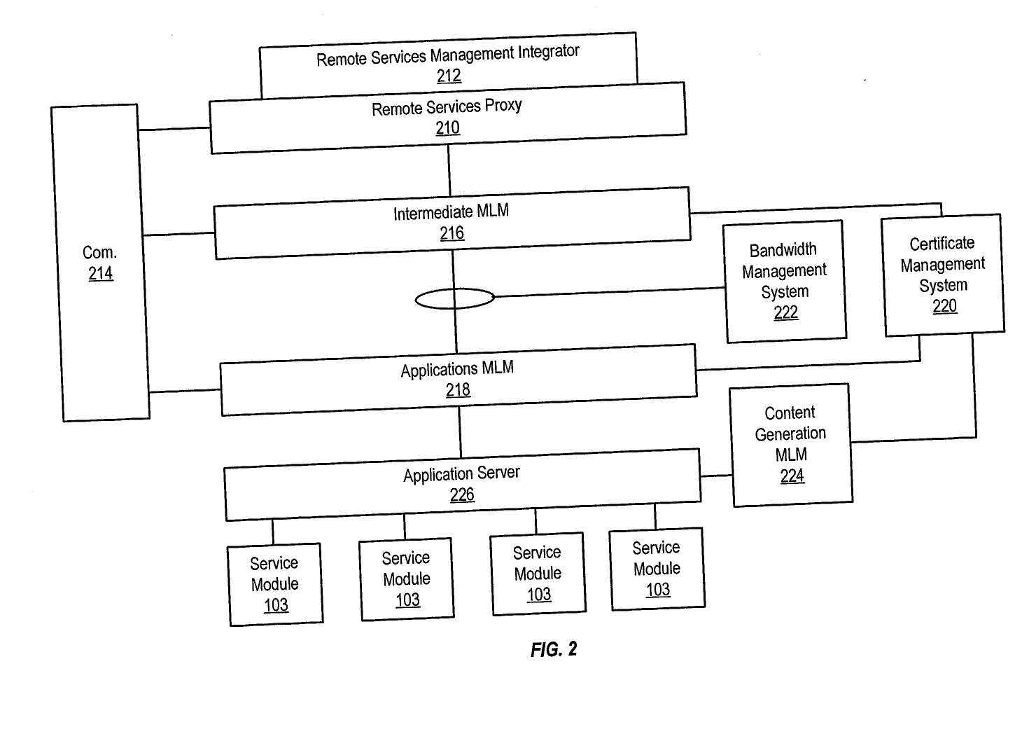

Referring to FIG. 2, the remote services infrastructure architecture 205 includes a plurality of components. More specifically, the remote services infrastructure architecture 205 includes a remote services proxy 210, a remote services system management integrator 212, a remote services communications module 214, an intermediate mid level manager (MLM) 216 (which may be a customer MLM or an aggregation MLM), an applications MLM 218, a certificate management system 220, a bandwidth management system 222, a remote services content generation MLM 224, a remote services application server 226. The remote services infrastructure architecture 205 interacts with a plurality of external service modules 103.

The remote services proxy 210 provides an API to the systems management systems. This API supports data normalization to the remote services data format. The remote services proxy 210 also provides receptors for the communications modules and in turn provides communications flow management using queuing. The remote services proxy 210 also manages allocation of remote services identifiers (ID's), which are allocated to each component of the remote services infrastructure, and the support instances that are registered with the remote services system 100.

The remote services system management integrators 212 are written to a remote services integrator API supported by the remote services proxy 210. One remote services proxy 210 can support many integrators (also referred to as integration modules). The integration modules provide the glue between the remote services system 100 and the systems management platform. There is at least one integration module for each support systems management platform.

The remote services communications modules 214 provide protocol, encryption and communications authentication. These modules plug-in through a semi-private interface into the remote services proxy 210, the intermediate MLM 216 and the remote services application MLM 218.

The intermediate MLM 216 may be either a customer MLM or an aggregation MLM. The remote services customer MLM is an optional deployable component. The remote services customer MLM provides a higher level of assurance to the customer-deployed environment, providing transaction integrity, redundancy and data queue management. The remote services customer MLM also provides an extensible environment through an API where service module components can be deployed. When no customer MLM is deployed, the aggregation MLM, hosted by the remote services provider and handling multiple customers, provides the data queue management, transaction integrity and redundancy. While the customer MLM is very similar to an aggregation MLM, a customer MLM may be required by a service module that needs to be localized. An aggregation MLM, being shared by multiple customers, may not be customizable.

The applications MLM 218 provides a series of functions that can exist on different MLM instantiations as applicable. The applications module provides data normalization, integration with the mail server data flow and integration with the certificate management system 220. This module acts as the gateway to the remote services application server 226 and controls data access.

The certificate management system 220 provides management of certificates to verify connection authentication for the remote services system 100. The certificate management system 220 may be horizontally scaled as necessary to meet the load or performance needs of the remote services system 100.

The bandwidth management system 222 provides control over bandwidth usage and data prioritization. The bandwidth management system 222 may be horizontally scaled as necessary to meet the load or performance needs of the remote services system 100.

The remote services content generation MLM 224 provides HTML content based on the data held within the remote services application server 226. This module provides a high level of HTML caching to reduce the hit rate on the application server for data. Accordingly, visualization of the data is done through the content generation MLM 224. Separating the visualization processing in the content generation MLM 224 from the data processing in the applications server 226 provides two separate scale points.

The remote services application server 226 provides the persistent storage of remote services infrastructure information. The application server 226 also provides the data processing logic on the remote services infrastructure information as well as support for the service module API to create service module processing within the application server 226. The application server 226 provides access to directory services which support among other things, IP name lookup for private network IP management. The application server 226 also provides access to the service modules 103.

In operation, the remote services proxy 210 uses the communication module 214 to connect to the intermediate MLM 216, whether the intermediate MLM is a customer MLM or an aggregation MLM. The applications MLM 218 and the intermediate MLM 216 use the certificate management system 220 to validate connections from customers. Dataflow bandwidth between the intermediate MLM 216 and the applications MLM 218 is controlled by the bandwidth management system 222. Data that has been formatted by the applications MLM 218 is sent on to the application server 226 for processing and persistent storage.

The content generation MLM 224 provides visualization and content creation for users of the remote services system 100. Remote services infrastructure administration portal logic is deployed to the content generation MLM 224 to provide users of the remote services system 100 with the ability to manage the remote services system 100.

All of the remote services components are identified by a unique remote services identifier (ID). A unique customer remote services ID is generated at customer registration. For remote services infrastructure components, remote services IDs are generated, based on the customer remote services ID, at a component registration phase. For remote services entities reporting to a remote services proxy 210, such as a support instance or an integration module, the remote services ID is allocated by the proxy 210 itself, based on the remote services ID of the proxy 210.

Within the remote services architecture, there are instances where detection, collection and management logic (also referred to as systems management logic) may have already been created by another service module. In this instance, the service module creator reuses this functionality. The reuse then creates a more complex relationship within the system to be managed. The segmentation and re-use of data is available within the architecture. Instrumentation is made up of a large number of small data types. These data types are shared by the different service modules 103 using a publish and subscribe model.

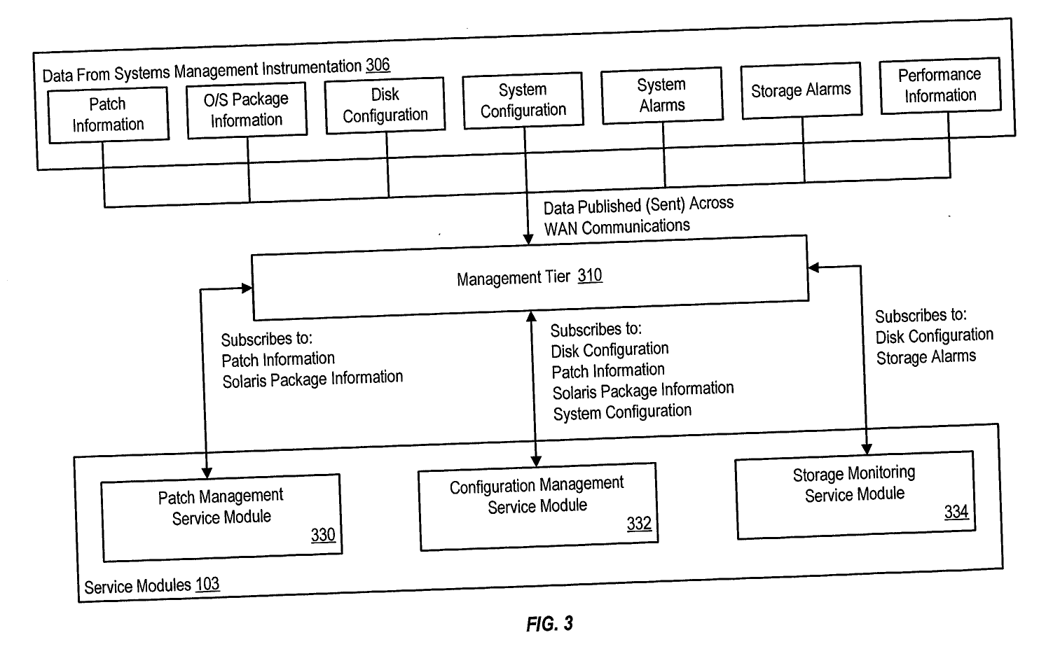

In a publish and subscribe model, the remote services proxies (and therefore the systems management systems) publish their data to a service provider. The service modules 103 register interest in specific types of data that are needed to fulfill the respective service module processing. FIG. 3 provides an example of the publish and subscribe model using example data and services.

More specifically, data from a systems management instrumentation proxy 306 may include patch information, operating system package information, disk configuration information, system configuration information, system alarms information, storage alarms information and performance information. This information is published via, e.g., a wide area network (WAN) to a management tier 310. Various service modules 103 then subscribe to the information in which they are respectively interested. For example, a patch management service module 330 might be interested in, and thus subscribe to, patch information and operating system package information. A configuration management service module 332 might be interested in, and thus subscribe to, the disk configuration information, the patch information, the operating system package information and the system configuration information. A storage monitoring service module 334 might be interested in, and thus subscribe to, disk configuration information and storage alarms information.

Thus, with a publish and subscribe model, many different types of data are published by a customer using the remote services customer deployed infrastructure. Service modules then subscribe to these data types. More than one service module 103 can subscribe to the same data. By constructing the instrumentation data in a well segmented manner, the data can be shared across many services.

Sharing data across many services reduces duplication of instrumentation. By making data available to newly developed service modules, those service modules need to only identify instrumentation that does not exist and reuse and potentially improve existing instrumentation. Sharing data across multiple services also reduces load on customer systems. Removing the duplication reduces the processing load on the customer's systems. Sharing data across multiple services also reduces development time of service modules 103. As more instrumentation is created and refined, service modules 103 reuse the data collected and may focus on developing intelligent knowledge based analysis systems to make use of the data.

Accordingly, the separation and segmentation of the infrastructure from the service modules enables services to be created in a standardized manner ultimately providing greater value to the customer.

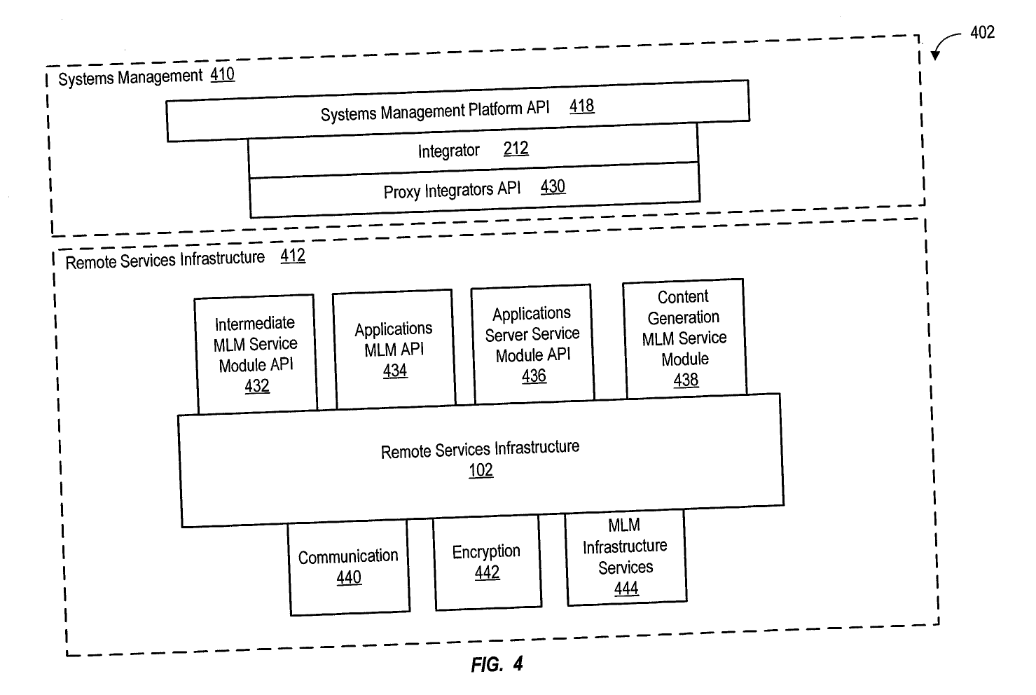

Referring to FIG. 4, the remote services architecture includes a remote services API 402 which may be conceptualized in two areas, systems management API's 410 and remote services infrastructure API's 412.

The systems management API's 410 includes systems management API's 418, integrator 212 and proxy integrators API 430. The proxy integrator API 430 interfaces with integrator module service logic. The integrator module service logic is a general term for the configuration rules that are imparted on the systems management system to collect or detect the information for the integrator 212. While the proxy integrator API's 430 are not technically a part of the remote services system 100, the proxy integrator API 430 is used within the integration modules which form the boundary between the remote services system 100 and the system management. The integration module creator provides the instrumentation to fulfill the collection and detection needs of the service via the systems management API 418.

The proxy integrators API 430 provides an interface between the systems management system and the remote services infrastructure 102. This interface provides a normalization point where data is normalized from the system management representation to a remote services standard. By normalizing the data, the remote services system 100 may manage similar data from different systems management systems in the same way. The proxy integrators API 430 interfaces with the remote services proxy 210 as well as the systems management integrator 212.

The remote services infrastructure API's are used by a service module creator and the systems management integrator 212. The remote services infrastructure API's 412 include an intermediate MLM Service Module API 432, an applications MLM API 434 and an applications server service module API 436 as well as a content generation MLM service module API 438. These API's provide the interface with the remote services infrastructure 102.

The intermediate MLM Service Module API 432 describes a distributed component of the infrastructure. The intermediate MLM service module API 432 allows modules to be loaded into this distributed component that provides mid data stream services such as data aggregation, filtering, etc. The intermediate MLM service module API 432 provides access and control over the data that flows through the intermediate MLM 216 to the service module provider. The intermediate MLM service module API 432 allows intercept of data upstream and on the back-channel to mutation, action and potential blocking by the service modules 103. The intermediate MLM service module API 432 interfaces with a service module creator as well as with the intermediate MLM 216 and intermediate MLM based service modules.

The applications MLM API 434 allows additional modules to be loaded on the applications MLMs. The applications MLM API 424 allows modules to be built into the applications MLMs 218 such as data normalization. The applications MLM API 424 interfaces with the applications MLMs 218 and modules within the applications MLM 218.

The applications server service module API 436 provides all of the needs of a data processing service module. The applications server service module API 436 provides access to many functions including data collected through a database and access to a full authorization schema. The applications service module API 436 is based around the J2EE API. The applications service module API 436 provides a rich interface for service module creators to interact with and build services based on Enterprise Java Beans (EJB's) and data available to them. The application server service module API 436 interfaces with the remote services application server 226 and the service modules 103.

The content generation MLM API 438 is based around the J2EE web container and provides the service module creator a way of building a browser based presentation. The content generation API 428 interfaces with the content generation MLM 224 as well as with MLM generation based service modules.

The remote services infrastructure API's 412 also include a plurality of communication interfaces which are based around the extendibility of the remote services communications system. The communication interfaces include a communication protocol module 440, a communication encryption module 442 and an MLM infrastructure services portion 444. The communications interfaces interface with the remote services proxy 210 as well as all of the remote services system MLM's. The communications interfaces provide an interface between the communications modules and the components that use the communications modules.

The communications protocol module 440 provides support of the application level protocol that is used for the communication through the system. Modules of this type interface to support the use of Email and HTTP communications protocols. The communication protocol module 440 interfaces with remote services communications engineering personnel.

The communications encryption module 442 supports plug-in encryption modules. The plug-in encryption modules can either provide encryption at the protocol level or encryption of the data within the protocol. The communication encryption module 442 interfaces with remote services communications engineering personnel.

The MLM infrastructure services portion 444 represent a number of services that are included within the MLM that provide services that are relevant to the infrastructure 102. These services manage and manipulate the data as it passes through the different parts of the architecture. These services, such as queuing, utilize an API to access and manipulate the API.

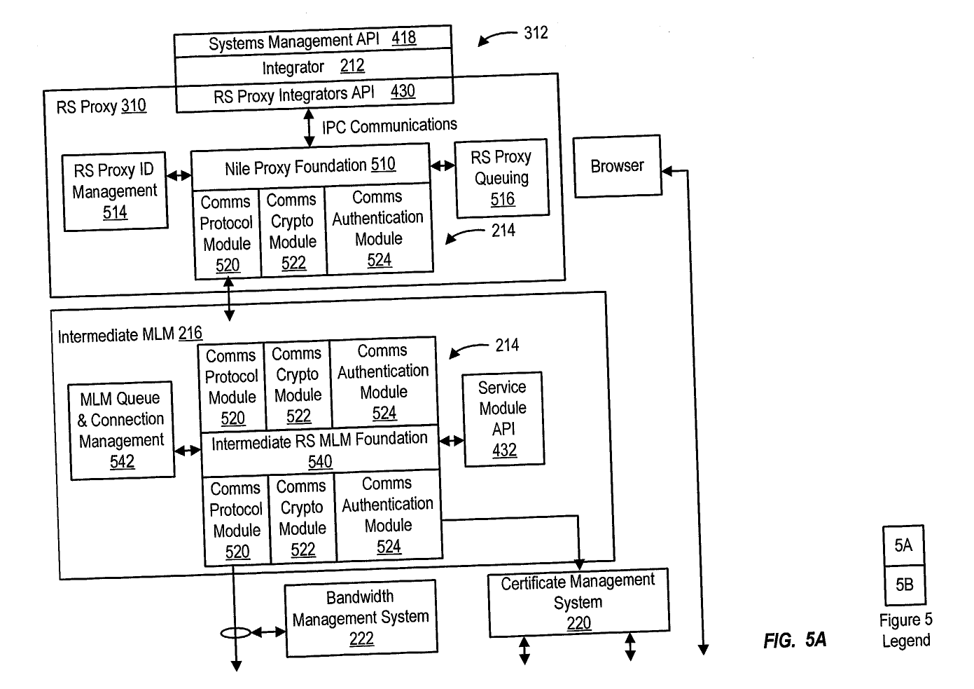

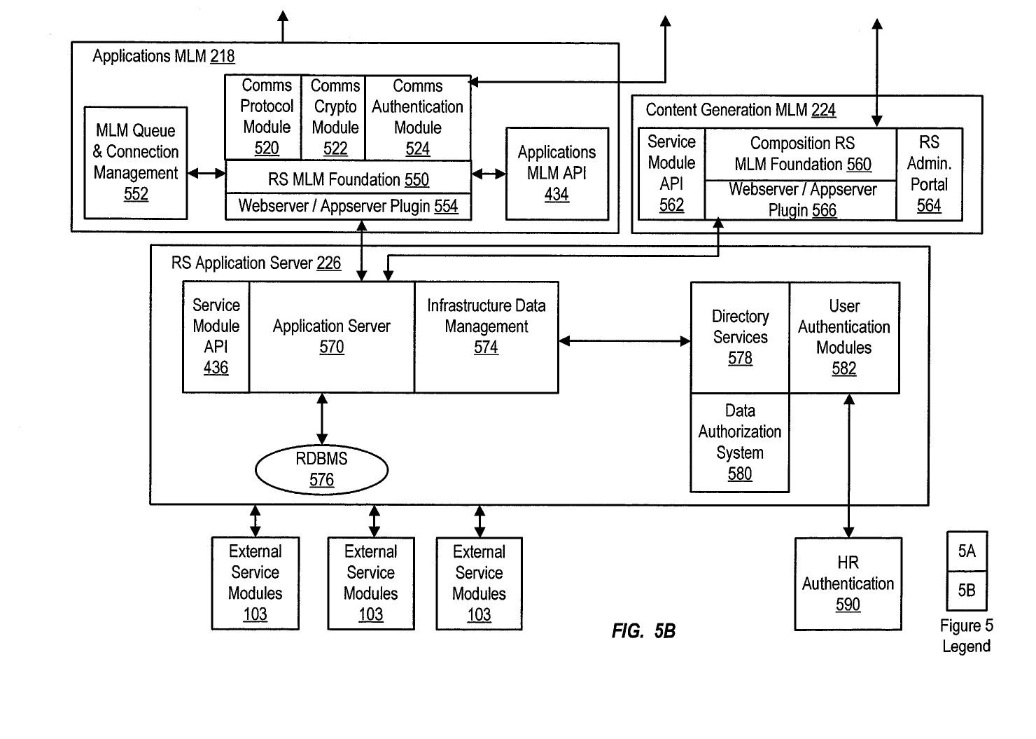

FIGS. 5A and 5B show a more detailed block diagram of the remote services architecture depicted in FIG. 2. Within this more detailed block diagram, the remote services communications modules 214 are shown distributed across the remote services proxy 210, the intermediate MLM 214 and the applications MLM 218.

The remote services proxy 210 includes a remote services proxy foundation module 510 which is coupled to a communications module 214 as well as to a remote services proxy integrator API module 430, a remote services proxy ID management module 514 and a remote services proxy queuing module 516.

The remote services system management integrator 212 includes a systems management API 418 and a remote services integrator 212. The remote services integrator 212 is coupled to the remote services proxy integrators API module 430 of the remote services proxy 210.

Each communication module 214 includes a communications protocol module 520 and a communications crypto module 522. A communications module 214 may also include a communications authentication module 524.

The intermediate MLM 216 includes an intermediate remote services MLM foundation module 540 which is coupled between communication modules 214. The intermediate remote services MLM foundation module 540 is also coupled to a MLM queue and connection management module 542 and an intermediate service module API module 432. Communications modules 214 couple the intermediate MLM 216 to the remote services proxy 210 and the applications MLM 218.

Bandwidth management system 222 controls bandwidth usage and data prioritization on the communications between intermediate MLM 216 and applications MLM 218. Certificate management system 220 is coupled between the communications authentication modules 524 for the intermediate MLM communications module 214 and the applications MLM 218 communications module 214.

The applications MLM 218 includes a remote services MLM foundation module 550 that is coupled to the communications module 214 for the applications MLM 218. The remote services MLM foundation module 550 is also coupled to an MLM queue and connection management module 552 and the applications MLM API module 434 as well as a web server application server plug-in module 554.

Content generation MLM 224 includes a composition MLM foundation module 560. The composition MLM foundation module 560 is coupled to a service content generation module API module 438 and a remote services administration portal 564 as well as a web server application server plug-in module 566.

Remote services application server 226 includes an application server module 570 coupled to an application server service module API 436 and an infrastructure data management module 574. The application server module 570 is also coupled to relational database management system (RDBMS) 576. The infrastructure data management module 574 is coupled to a directory services module 578. The directory services module 578 is coupled to a data authorization system module 580 and user authentication modules 582. The user authentication modules 582 are coupled to human resources (HR) authentication module 590. The remote services application server 226 is coupled to a plurality of external service modules 230.

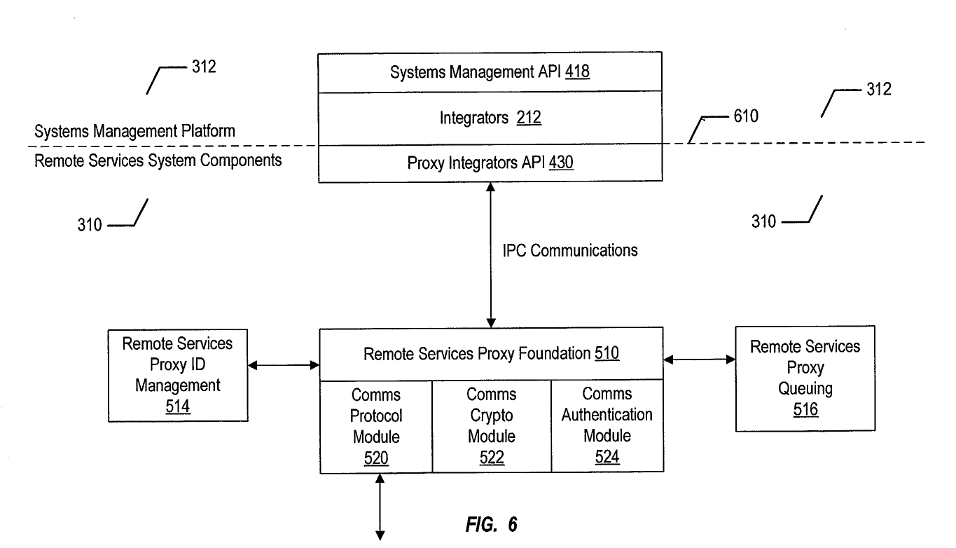

FIGS. 6, 7, 8, 9 and 10 show expanded views of the remote services proxy 210 and remote services system management integrator 212, intermediate MLM 216, applications MLM 218, applications server 226 and content generation MLM 224, respectively.

FIG. 6 shows a block diagram of the remote services proxy 210 and the remote services system management integrator 212. The block diagram shows the delineation between the systems management software and the remote services system components as indicated by line 610.

The remote services proxy 210 provides an API via remote services proxy integrators API 430 which communicates using the operating system's Inter-Process Communication (IPC) implementation with the remote services proxy foundation module 510. This communication allows the API to be implemented with a number of different languages to meet the needs of the systems management developers while leaving a single native implementation of the remote services proxy foundation module 510. Examples of the languages used for the API include Java and C++.

The remote services proxy foundation module 510, together with the API 430, manage data normalization tasks. This ensures that systems management data is carried independently through the system. For example, an event from one type of service, such as a SunMC service, would have the same structure as an event from another type of service, such as the RASAgent service. Accordingly, the service modules may deal with the data types that are specific to the respective service and are independent of their source.

In the remote services architecture, the integrator 212 and proxy 210 are represented by two separate processes (e.g., address spaces). By representing the integrator 212 and the proxy 210 as two separate processes, a faulty integrator 212 is prevented from taking down the whole proxy 210.

The remote services proxy queuing module 516 allows data to be queued for transmission when communications to the intermediate MLM(s) 216 become unavailable. This queuing is lightweight and efficient which in turn reduces the capabilities of length of time data can be queued and of reconnection management. The remote services proxy queuing module 516 provides a number of features that can be used to manage the queue, such as priority and time for data to live.

The remote services proxy ID management module 514 manages the allocation of unique identifiers for the proxy 210 itself and any support instances that are registered through the API. The remote services system 100 relies on the creation of unique ID's to manage individual support instances. This function is provided within the proxy 210 because there is no unique cross platform identifier available within the remote services system 100. The proxy 210 manages the mapping between the systems management ID (e.g., IP address) and the remote services ID, which is keyed off the unique customer ID provided at installation time within the deployed system.

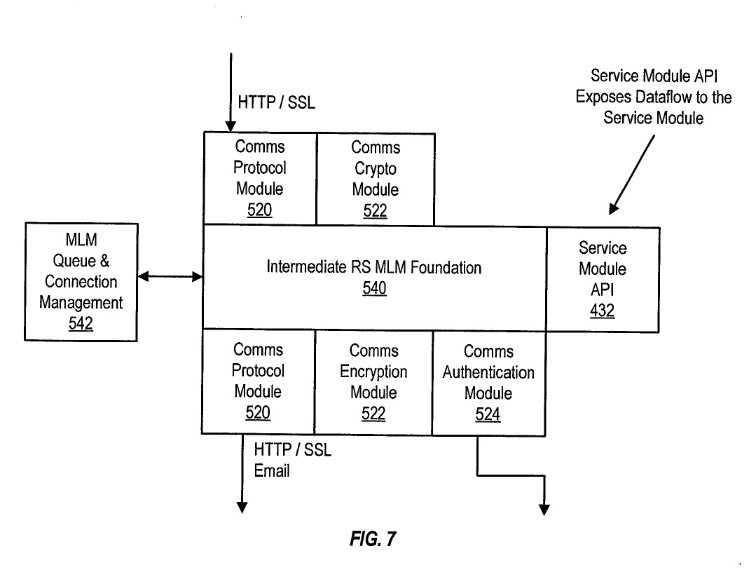

FIG. 7 shows a block diagram of the remote services intermediate MLM 216. The intermediate MLM may be a customer MLM or an aggregation MLM.

The customer MLM is an optional component that can be deployed to support scaling of both support instances and services as well as provide enhanced availability features for a deployed remote services environment. The intermediate MLM 216 receives information via the HTTP protocol from the remote services proxy 210. This information may optionally be encrypted. Connections are not authenticated by default on the server side, as it is assumed that the connection between the intermediate MLM 216 and the proxy 210 is secure.

The intermediate remote services MLM foundation module 540 exposes the data flow to the service module API 432 where registered service modules can listen for new data of specific types and mutate the data as required. Examples of this function include filtering of certain types of data or data aggregation. The customer MLM does not keep state from an infrastructure perspective. However, the service module could choose to keep persistent state information. The recoverability fail-over support of that state, however, is in the domain of the service module, although the basic session replication features that provide the redundancy features of the infrastructure data flow may be reused.

The queue and connection management module 542 provides a highly reliable secure connection across the wide area network to the service provider based MLM farms. The queue manager portion of module 542 also manages back-channel data that may be intended for specific remote services proxies as well as for the applications MLM 218 itself.

The intermediate remote services MLM foundation module 540 manages the rest of the MLM's roles such as session management, fail-over management and shared queuing for the back-channel.

Aggregation MLM's, while provided by the service provider, function much the same as customer MLM's. Strong security is turned on by default between such MLM's and the remote services proxy 210. Accordingly, a communications authentication module 524 is used on the receiving portion of the intermediate MLM 216.

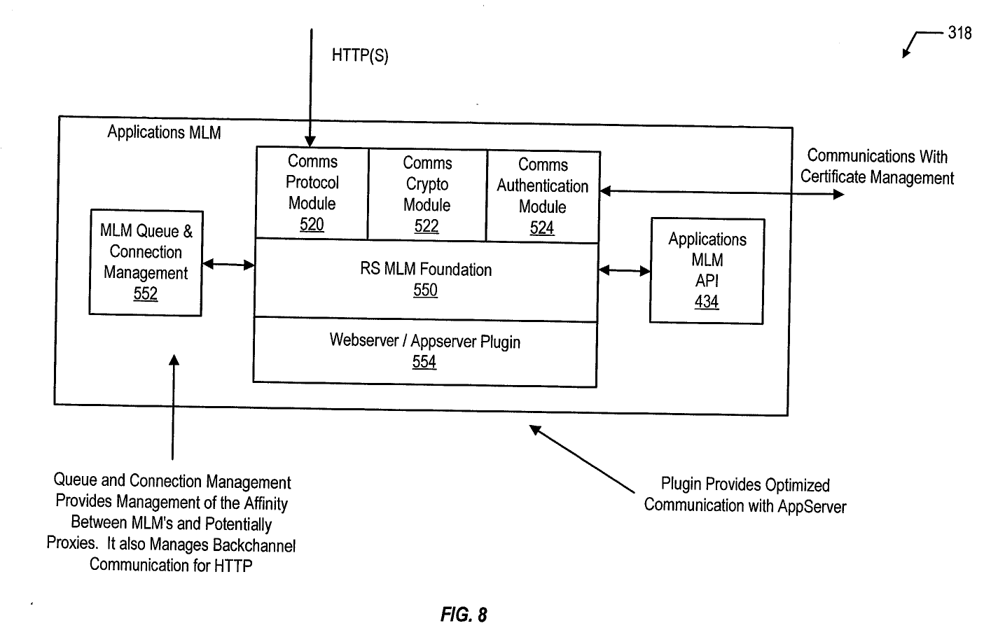

Referring to FIG. 8, the remote services application MLM 218 provides several functions (applications) for the remote services system 100. The remote services application 218 hosts applications as well as functioning as a content creation MLM. The host applications within the application MLM 218 include data normalization, customer queue management and remote access proxy. The data normalization application supports normalization and formatting of data being sent to the application server 226. The customer queue management application handles general connections to and from customer remote services deployments. The customer queue management application also manages back-channel requests and incoming request. The remote access proxy application provides a remote access point as well as functioning as a shared shell rendezvous point. The applications MLM 218 uses the application server plug-in to communicate directly with the application server 226.

The communications authentication module 554 communicates with the certification management system 220 to validate incoming connections from customers. Each customer is provided a certificate by default although more granular allocations are available. Certificates are distributed at installation time as part of the installation package for both the remoter services proxy module and for the remoter services customer MLM.

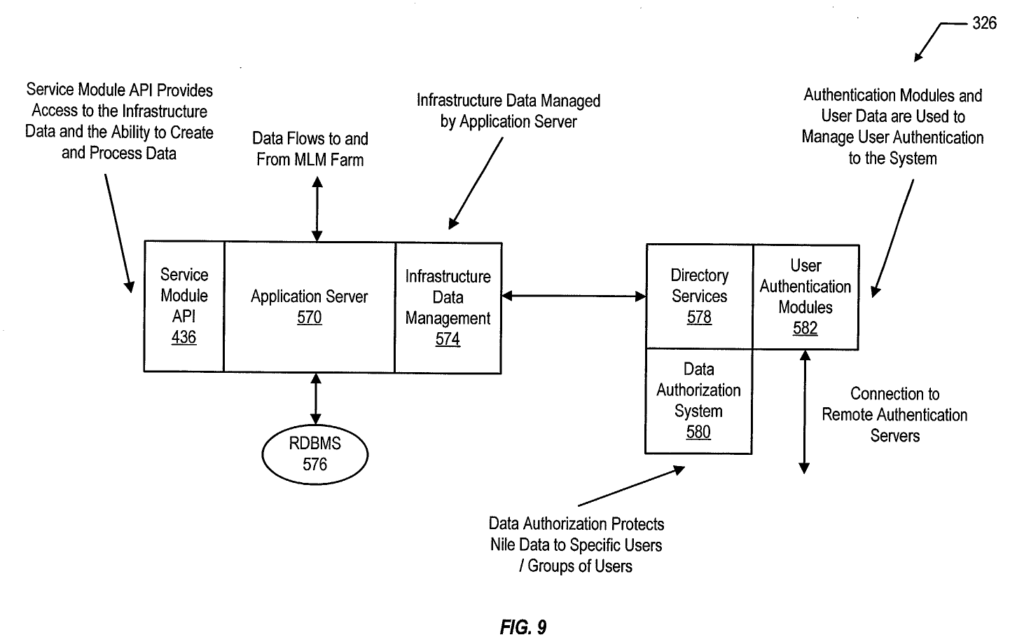

Referring to FIG. 9, the application server 226 manages the persistence and data processing of the remote services infrastructure 102 and the service modules 103.

The application server 226 provides the core service module API 436 to the service module creator. The service module API 436 is based upon the J2EE API. The service module API 436 allows the service module creator to register for certain types of data as the data arrives and is instantiated. This data can then be processed using the support of the application server 226 or alternatively exported from the remote services system 100 for external processing.

The infrastructure data is held within the application server 226 and stored within the RDBMS 576 associated with the application server 226. Access to this data is available via the service module API 436 and is managed via the infrastructure data management module 574.

The directory services implementation supports user authentication, data authorization and private network data support. User authentication uses a pluggable authentication module (PAM) so support a plurality of authentication methods such as a lightweight directory assistance protocol (LDAP) method for service provider employees and a local login method for a remote services based login schema. Other methods may be added. The LDAP login is processed using a replicated copy of an LDAP server running within the remote services infrastructure 102.

Data authorization is designed to protect the data held within the application server 226 to specific groups of users. This protection allows customers to grant or deny access to their service data to specific users. This data protection is managed down to the service module granularity. So for example, a customer could grant information about advanced monitoring on a subset of their support instances to members of a service provider monitoring staff.

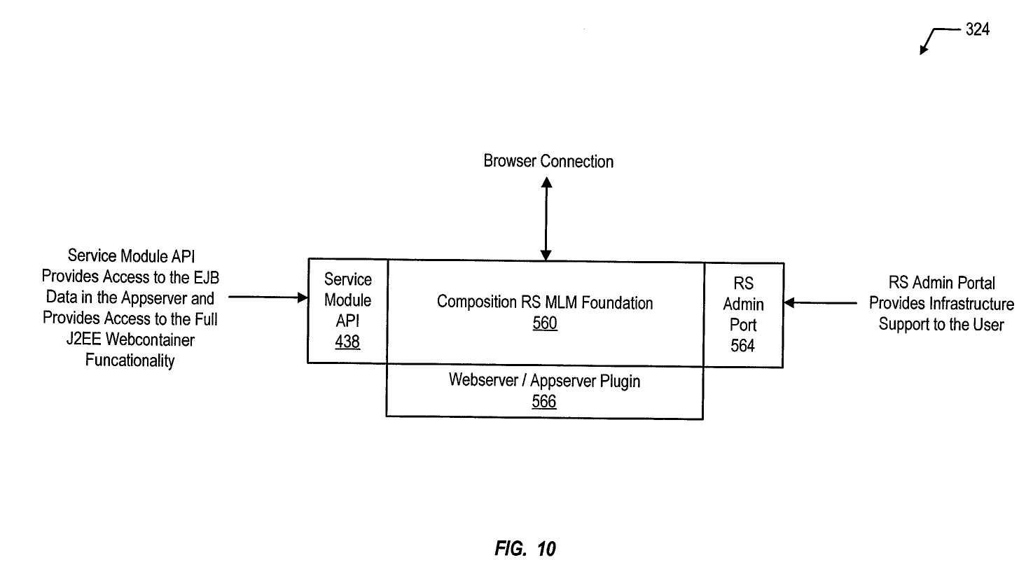

Referring to FIG. 10, the remote services content generation MLM 224 provides HTML generation bases on the data held within the application server 226. The content generation MLM 224 provides a service module API 438 for service module creators to develop content composition for their data which is processed by the application server 226. The content is in the form of J2EE web container which supports Java servlets and Java servlet pages (JSP) API's.

The content generation MLM 224 communicates with the application server 226 using the same Netscape API (NSAPI) plug-in as the remote services applications MLM 218. Instances of these two MLMs make up an MLM farm. The composition remote services foundation layer provides support for caching of HTML pages and associated data to reduce the data request hit back to the application server 226.

The remote services administration portal 564 provides control of the deployed customer infrastructure to the customer and control over the total infrastructure to trusted users.

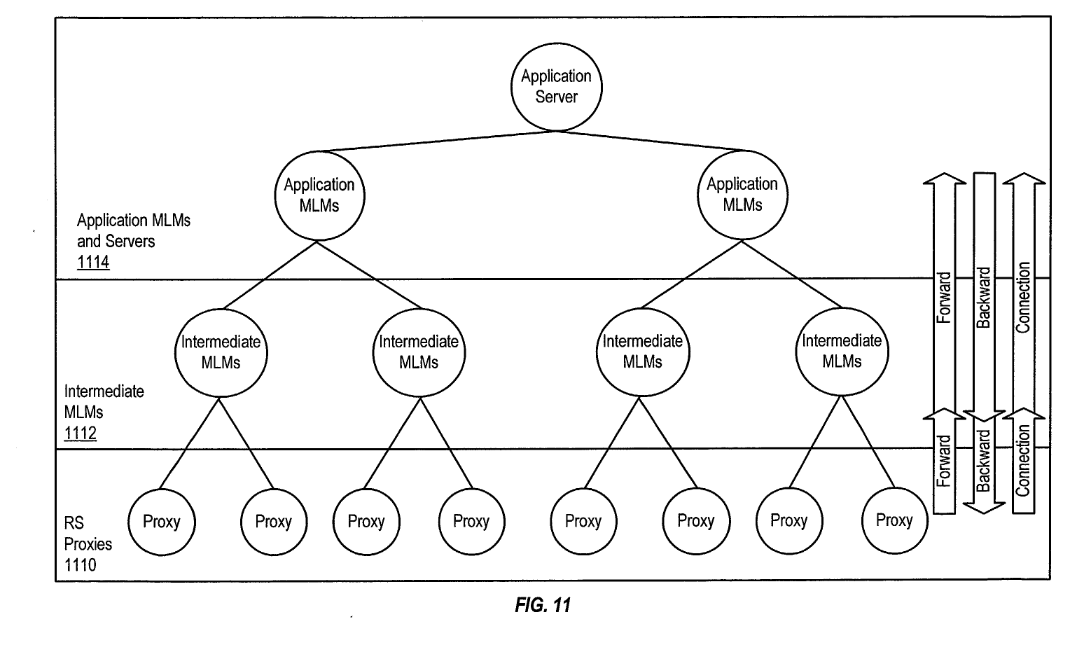

FIG. 11 shows a flow diagram of communications within a remote services architecture. In one embodiment, the communications between a customer and a service provider is via a wide area network (WAN). Communications within the remote service architecture includes three tiers, a remote services proxy tier 1110, an intermediate MLM tier 1112 and an application MLM and server tier 1114. Communication is established and connections are made from the bottom tier (the remote services proxy tier) to the top tier.

The remote services architecture supports two application protocols for the majority of its services classification support: HTTP and Email messaging. There are a plurality of service module classifications that each have specific communications protocol relationships. More specifically, the service module classifications include a data collection classification, a monitoring classification, a remote access classification and an infrastructure administration classification.

With the data collection classification, the connection orientation is message based, the physical connection support may be Internet, private network or fax, and the protocols supported may be Email or HTTP. Examples of service modules of this classification include an inventory management service module and a performance management service module.

With the monitoring classification, the connection orientation is message based, the physical connection support may be Internet, private network or fax, and the protocols supported may be Email or HTTP. Examples of service modules of this classification include basic self service monitoring and full hardware monitoring with service action.

With the remote access classification, the connection orientation is session based, the physical connection support may be Internet, private network or fax, and the protocol supported is HTTP. The session based connection orientation is one way initiation from the customer. Examples of service modules of this classification include remote dial in analysis and remote core file analysis.

With the infrastructure administration classification, the connection orientation is session based or off-line installation, the physical connection support may be Internet, private network or fax, and the protocol supported includes HTTP, email or physical (e.g., telephone or CD). The session based connection orientation is one way initiation from the customer and the off-line installation is via, e.g., a CD. Examples of service modules of this classification include remote services administration, installation, updates, configuration and notification.

Encryption options are related to the protocol. A secure socket layer (SSL) protocol, for example, is likely to be the chosen protocol for an HTTP transmission, i.e., an HTTPS transmission. The remote services communication architecture does not enforce this however. So, for example, data could be sent by encrypting the body of an HTTP stream. This provides an advantage when a customer's HTTPS proxy infrastructure is not as resilient as their HTTP proxy infrastructure.

Email uses an email encryption option such as s-mime or encrypting the body using a third party encryption method such as PGP. Encryption is optional at all stages. If the customer does not require encryption, then encryption need not be used.

Authentication of the remote services communication is standard for all protocols. Accordingly, the service provider may validate the sender of data and the customer may validate that the service provider is the receiver. Authentication is managed via certificates.

Certificates are used in both the client and server to authenticate a communications session. Client certificates are generated during the customer registration process and are built into the remote services proxy and the customer MLM. By default, each customer is provided a client certificate. The customer can, however, define specific security groups within their service domain and request additional client certificates for those domains. Remote services processes include a certificate distribution mechanism, supporting either the creation of a new security group within an existing customer or the redeployment of a new certificate after a certificate is compromised.

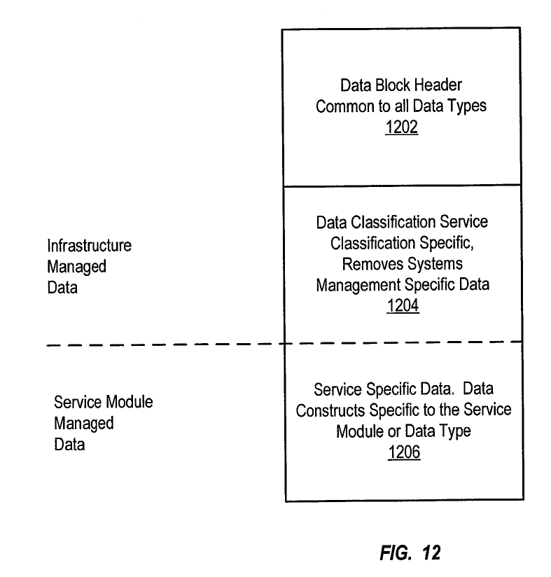

FIG. 12 shows a block diagram of the data blocks that comprise the data that flows through the remote services infrastructure. Each system management system conforms to the data definitions that are part of the remote services proxy integrators API 430. The remote services communications architecture provides a normalized view of the data, regardless of in which systems management framework the data originated.

Data block header 1202 is common to all data types. Data block header 1202 contains items such as source, routing information, time to transmit and source type. Data block header 1202 is used to route the data correctly through the remote services system 100 to the correct service module 103. Data block header 1202 is used to provide diagnostic and quality of service measurement built into the system.

Infrastructure data block 1204 provides data classification service classification specific data. Infrastructure data block 1204 removes systems management specific data.

Service module data block 1206 provides format based on each service classification that drives the system the systems management normalization of the data that flows through the system. For example, alarm data includes general characteristics defined such as severity, state and originating support instance.

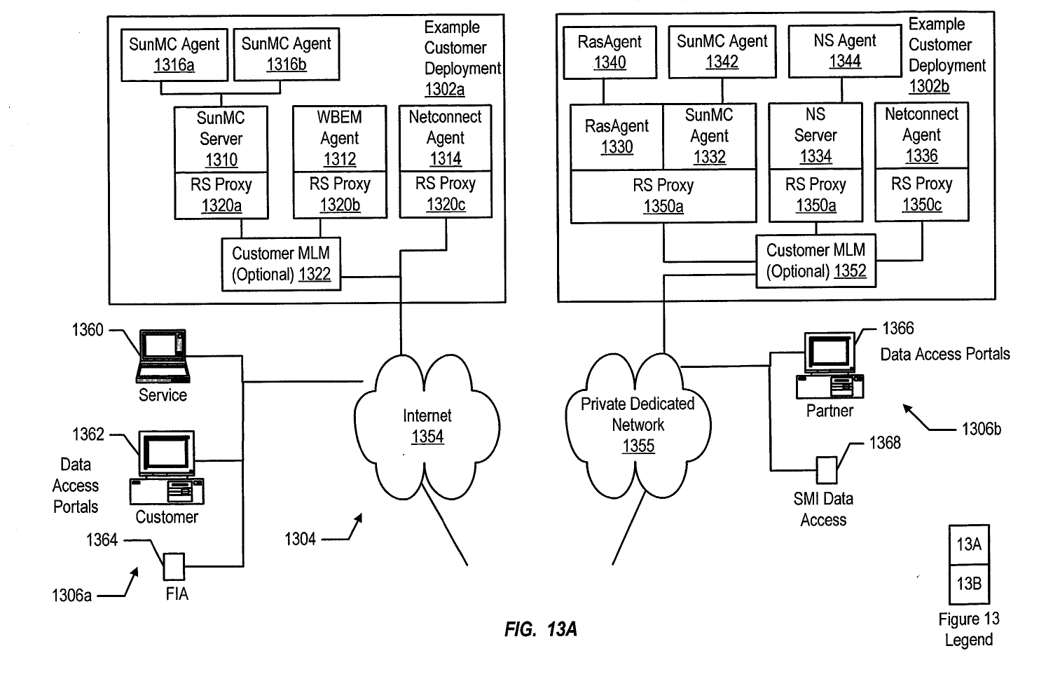

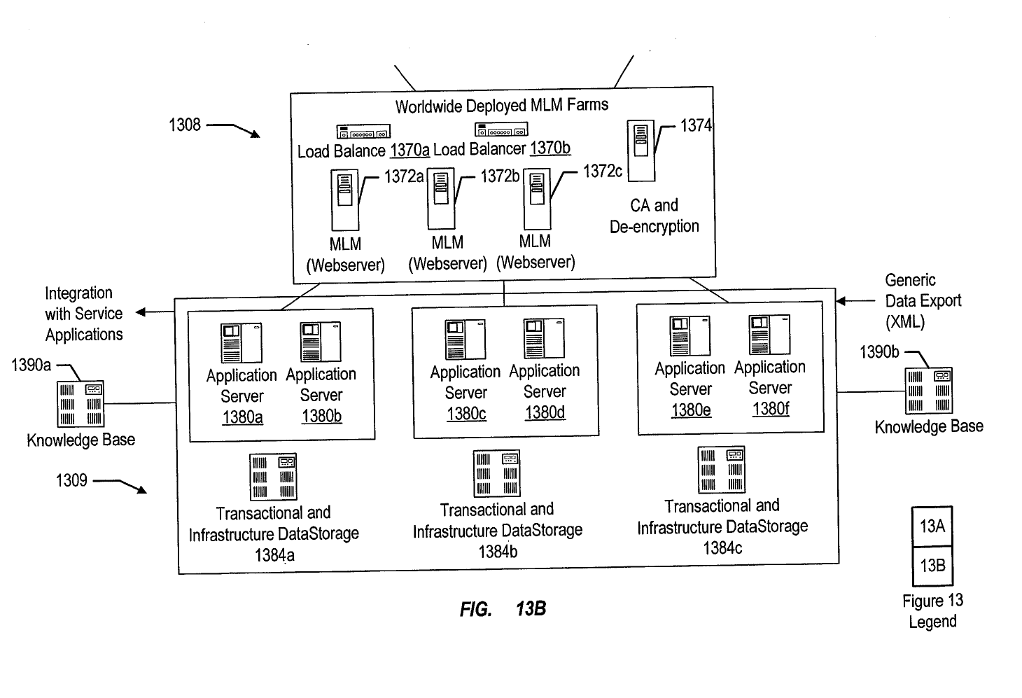

FIGS. 13A and 13B show an example of the component relationships of a remote services system 100 that is configured according to the remote services architecture. Various components of the remote services system 100 execute modules of the remote services infrastructure architecture 205. Remote services system 100 includes customer deployment portion 1302a, 1302b, network portion 1304, data access portal 1306a, 1306b, Mid Level Manager (MLM) portion 1308, and application server portion 309.

Customer deployment portion 1302a sets forth an example customer deployment. More specifically, customer deployment portion 1302a includes SunMC server 1310, WBEM agent 1312, and Netconnect Agent 1314. SunMC agents 1316a, 1316b are coupled to SunMC server 1310. Server 1310, Agent 1312 and Agent 1314 are each coupled to a respective remote services proxy 1320a, 1320b, 1320c. Remote services proxies 1320a, 1320b, 1320c are coupled to network portion 1304, either directly, as shown with proxy 1320c, or via customer MLM 1322, as shown with proxies 1320a and 1320b. Proxies 1320a and 1320b may also be directly coupled to network portion 304 without the MLM 1322 present. The SunMC server is a provider specific systems management server (i.e., health management server). The SunMC agents are provider specific systems management agents (i.e., health management agents). The WEBM agent is a web based enterprise management agent. The Netconnect agent is a basic collection agent. Customer deployment portion 1302a illustrates that the systems management may be 2-tier (e.g., agent, console) or 3-tier (e.g., agent, server, console).

Customer deployment portion 1302b sets forth another example customer deployment. More specifically, customer deployment portion 1302b includes RasAgent 1330, SunMC agent 1332, NS server 1334 and Netconnect Agent 1336. RasAgent 1340 is coupled to RasAgent 1330. SunMC Agent 1342 is coupled to SunMC Agent 1332. NSAgent 1344 is coupled to Netconnect Agent 1336. RasAgent 1330 and SunMC Agent 1332 are coupled to remote services proxy 1350a. Metropolis Server 1334 is coupled to remote service proxy 1350b. Netconnect Agent 1336 is coupled to remote services proxy 1350c. Remote services proxies 1350a, 1350b, 1350c are coupled to network portion 1304 either via customer MLM 1352 or directly. The RasAgent is a reliability, availability, serviceability agent. The NSagent is a network storage agent and the NS server is a network storage server. Both the NSagent and the NS server are reliability, availability, serviceability type devices.

Network portion 1304 includes at least one interconnection network such as the Internet 1354 and/or a private dedicated network 1355. Internet 1354 is assumed to be an existing connection that is reused by the remote services system. The private dedicated network 1355 is a dedicated link that is used exclusively by the remote services system to connect the customer to the service provider. The data to manage the private network is provided by directory services technology held within the application server portion 1308. The directory services technology handles all of the domain name service (DNS) services used to manage name to allocated internet protocol (IP) information. The remote services infrastructure also offers transmission over fax from the customer's environment (not shown). The fax communication is for service modules where the fax transmission makes sense. For example, fax transmission may be used in a military site which does not allow electronic information to be transmitted from it.

Data access portal portions 1306a and 1306b provide access to the remote services system 100. More specifically, data access portal portion 1306a includes a service access portion 1360, a customer access portion 1362 and a field information appliance (FIA) 1364. Data access portal portion 1306b includes a partner access portion 1366 and a system management interface (SMI) data access portion 1368.

Mid level manager portion 1308 includes load balancers 1370a, 1370b, MLM webservers 1372a, 1372b, 1372c and communication authentication (CA) and de-encryption server 1374.

Application server portion 1309 includes a plurality of application servers 1380a-1380f. Application servers 1380a, 1380b are associated with transactional and infrastructure data storage 1384a. Application servers 1380c, 1380d are associated with transactional and infrastructure data storage 1384b. Application servers 1380e, 1380f are associated with transactional and infrastructure data storage 1384c. Application server portion 1309 also includes knowledge base 1390a, 1390b. Application server portion 1309 integrates with service applications as well as via generic data export (such as, e.g., XML).

Remote services proxies 1320, 1350 provide a System Management Integrators API. Using this API, system management products can integrate their customized handling of data into the common data format that is used by the remote services architecture. Accordingly, the system management component of the overall system is effectively segmented away from the remote services architecture.

Additionally, by using the remote services proxies 1320, 1350, the remote services architecture leverages much of a pre-existing instrumentation and data collection mechanisms that already exist. Accordingly, already deployed instrumentation agents within a remote service provider existing system such as those from SunMC and Netconnect may be integrated into a remote services system. Additionally, third party systems management systems may also be supported and integrated via the remote services proxies.

Customer deployment portions 1302a, 1302b each show an optional customer MLM component deployed to the customers environment. Whether to deploy the customer MLM component depends on a number of factors. More specifically, one factor is the number of support instances installed in the customer's environment and the number of services being utilized by the customer. A deployed MLM component can allow greater scale capabilities. Another factor is the type of services deployed within the customer environment. Some services are optimized when an MLM component is deployed to the customer environment to support service specific tasks such as filtering and data aggregation. Another factor is the quality of service. Deploying an MLM component provides a greater level of quality of service because the MLM component provides enhanced data communications technology within the MLM infrastructure modules.

The decision of whether to deploy a remote services MLM component (or more) to the customer's environment is a deployment decision. There are a number of architecture deployment classes which are used to meet the varying customer needs.

The remote services system communicates via two main protocols, HTTP and email. Security considerations for these protocols can be chosen by the customer and plugged into the system. For example, the HTTP protocol may use SSL. Additionally, the email protocol may use some well known form of encryption.

The connections from the customer deployment portion 1302 feed into MLM farms which reside within the SMI service provide environment. These MLM farms are sets of redundant web servers 1372 that are balanced using conventional load balancing technologies. Alongside these web servers 1372 are infrastructure servers 1374 which provide specific infrastructure acceleration for decryption and distribution of certificates for communications authentication.

These MLM farms provide a plurality of functions. The MLM server farms provide remote proxy connections. In deployments when an MLM is not deployed to the customer, the customer's proxy connects to the MLM farms within MLM portion 1308. Also, in deployments when a customer MLM 1322, 1372 is present, the MLM farm communicates and manages communication with the deployed customer MLM 1322, 1372. Also, the MLM server farms provide data processing capabilities, e.g., the MLM farms provide application specific tasks to prepare data for passing to the remote services application server portion 1309. Also, the MLM server farms provide access points for the customer and service personnel via browser like connections. The MLM farm generates the HTML that is presented to the browser.

The MLM technology is based upon known web server technology such as that available from Sun Microsystems under the trade designation iPlanet. Plug-in functionality is provided by the servlet and JSP interfaces available as part of the web server technology.

The remote services application servers 1380 provide data processing and storage for the remote services infrastructure as well as for any hosted service modules. The remote services application servers 1380 are based upon known application server technology such as that available from Sun Microsystems under the trade designation iplanet application server 6.0. The remote services application server 1380 provides support for horizontal scalability, redundancy and load balancing. Thus providing the back-end components of the remote services architecture with a high level of built in assurance and flexibility. Application partitioning of the application servers 1380 provides processing distribution to ensure that heavy processing that may be required by more complex services are handled appropriately without affecting the remainder of the remote services architecture.

Application server portion 1309 provides integration into existing business systems, generic data export and tight integration with existing knowledge base implementations 1390. Data export is handled through structured XML, data can be exported asynchronously by a client registering to receive data of a particular type or synchronously by the application server 1380 accepting a request from a client.

The core service module API is provided by the application server 1380 using a J2EE implement API. The basic container services of J2EE are extended to provide remote services specific functions and to create the basis of the API. Accordingly, a service module creator can rely on a number of provided for services, such as database persistency, high levels of atomic, consistent, isolated, and durable (ACID) properties, directory service access, authorization protection for the data and access to the data collected by the remote services infrastructure itself.

The creation of a service module, which provides the technology to support a specific remote service, involves at least one of the following components: a creation of detection/collection logic component; a mid-stream analysis and management of data component; an analysis and storage of data component; and, a presentation and management of the data/knowledge component.

The detection/collection logic is created within the domain of a systems management toolkit. The mid-stream analysis and management of data is an optional step and effectively provides analysis of the data within the customer's environment. Inclusion of this logic would mean that the mid-stream analysis and management of data service module would have a remote services MLM deployed to the customer's environment 1302a, 1302b. The deployment of the remote services MLM to the customer's environment reduces and manages the data being sent over the WAN to the remote services provider. The analysis and storage of data component is performed within the application servers domain (the component may be exported). This analysis and storage of data component turns data into knowledge and service value that can then be presented back to the customer. The presentation and management of the data/knowledge component is where the data and knowledge that is developed from the analysis and storage of data component is presented to the customer or service personnel. The presentation and management of data/knowledge component may include interactive support to provide modification of the data values.

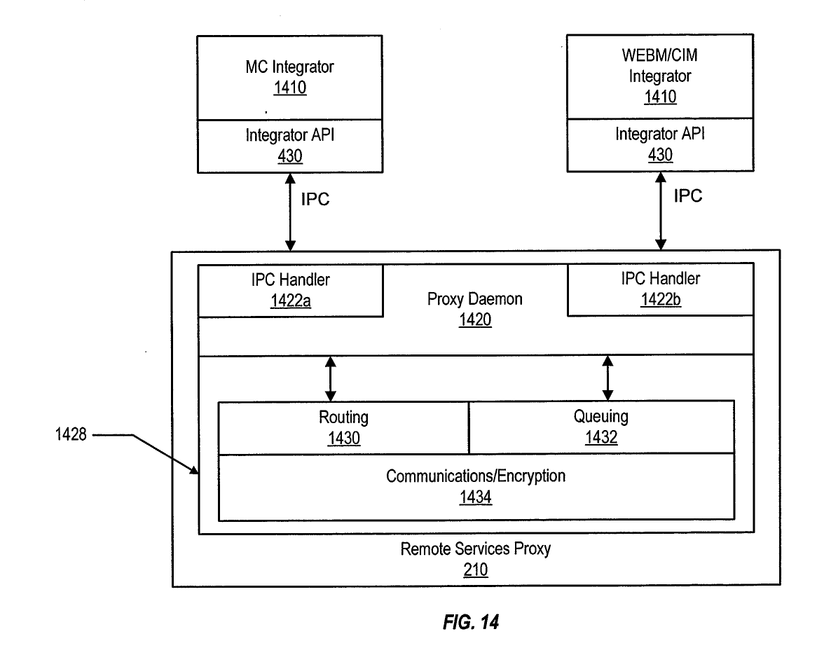

Referring to FIG. 14, remote services proxy 210 provides the interface between a systems management platform and the remote services infrastructure 102 on the customer site. The system management platform includes a plurality of integration modules 1410 which coupled to a remote services proxy 210 via a systems management integrator API 430. The remote services proxy 210 includes a proxy deamon 1420, as well as a plurality of IPC handlers 1422a, 1422b coupled to respective integrator API's 430. The proxy daemon 1420 is coupled to a communications module 1428 which includes a routing module 1430, a queuing module 1432 and a communications/encryption module 1434.

Communication between the integrator API 430 and the remote services proxy 210 is via an Inter-Process Communication (IPC) mechanism, local to the host, which is platform specific. For example, on a system running a Unix type operating system, this communication might be via shared memory, message queues, unit-domain Berkley System Design (BSD) sockets or named pipelines. Alternately for example, on a system running a Windows NT operating system, this communication might be via shared memory, named pipelines or COM.

While the communication between the proxy daemon 1420 and the remote services proxy 210 stays local to the host, the communication between the proxy daemon 1420 and the agent or system management may use networked IPC.

The remote services proxy daemon 1420 is tightly coupled to the proxy 210 and provides infrastructure management services to the proxy 210, such as software upload, software updates and proxy status.

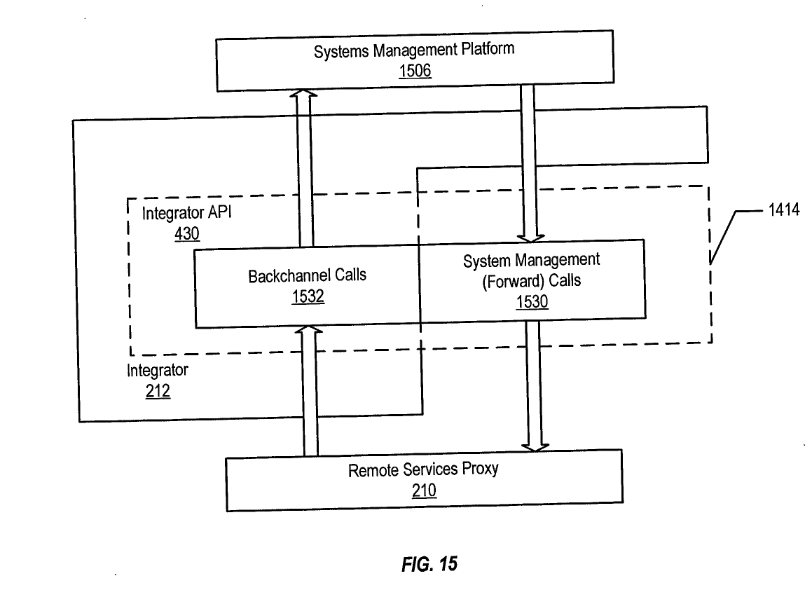

Referring to FIG. 15, the system management integrator API 430 provides a mechanism by which data can be sent from the systems management platform 1506 to the remote services system 100 and received by the systems management platform 1506 from the remote services system 100.

There are two components to the system management integrator API 430, a forward calls component 1530, which provides forward calls from the system management platform 1506 to the proxy 210, and a back-channel calls component 1532, which provides back-channel calls from the proxy 210 to the system management platform 1506. The forward calls component 1530 is implemented by the service provider. The back-channel calls component 1532 is implemented by the developer of the integration module.

Bindings are provided for the systems management integrator API 430 in both the C programming language and the Java programming language. Bindings for other programming languages may also be provided. The access to the IPC facilities, the Java binding may use native Java calls such as Java Native Interface (JNI) calls.

The systems management integrator API 430 provides generic message interfaces as well as some more specific interfaces (such as, e.g., sendEvent and sendAlarm). The more specific interfaces are provided so that messages can be wrapped to make it easier for services modules 103 on the MLM's to determine whether or not the service module needs to handle the message without detailed introspection of the message contents.

The systems management integrator API 430 provides function calls which facilitate generating appropriate XML headers for the message to be posted to the remote services system 100. For example, to send an event, the systems management integrator API 430 provides a function which includes parameters for the event type, severity and state.

While Alarm and Event are two specific types of messages which can be sent to the remote services system 100, the generic message is simply data. Because the service modules 103 running with the remote services application server 226 need to know about a particular message to determine whether or not the service module 103 should process the message, it is important that the class of the data is set. The classification and sub-classification of these generic messages is a responsibility of the integrator 212 and is set by the parameters in the API call: sendData. Because the integrator 212 itself does not know about all different data types, it is the function of the integrator 212 to get the data class and subclass (if any) from the systems management platform 1506 before calling the setData API call. In some cases, the class may be the name of the module from which the data originated, on other cases, the class may be the systems management platform name itself (for e.g., simple data collectors).

Although the name and version of an integrator 212 are sufficient to identify the capabilities of the module to the application server 226, the systems management platform 1506 too may have capabilities which change over time. For example, an integrator 212 may get loaded into an agent to provide, e.g., patch management capabilities. The capabilities may be required by certain service modules to provide a service. However, unless the service module 103 can find out what the capabilities are from the system management platform 1506 (or agent), the ability of the service module 103 to take actions may be limited.

Accordingly, the systems management integrator API 430 provides support for declaring the capabilities of a support instance at registration time and for the request of the capabilities through a back-channel request at any time thereafter. The back-channel request is serviced by a forward-channel message containing the requested capabilities.

A capability set is described by a well formed XML string (e.g., a char*string) which is generated by the integrator 212 or by the systems management platform 1606.

Where return values in the C API programming language calls are shown as int, the return values follows the standard Unix pattern: 0 for success; −1 for errors which relate to parameter values (the global variable errno is set to indicte the nature of the problem more precisely) −2 for errors which occur as a result of some infrastructure problem either in the remote services proxy 210 or in the system management integrator API 430 (the srserrno global variable is set to indicate the nature of the failure).

The following table shows a set of API calls which are available to the integrator 212 for forward communication with the remote services system 100.

More specifically, Table 1 sets forth a set of integrator forward API calls for the C programming language.

TABLE 1

| | Return | Return Type | | Parameter | |
|---|---|---|---|---|---|
| Function Name | Type | Description | Parameter | Type | Parameter Description |
| register | Int | 0 on success or | moduleName | char* | Name of the Integration |
| | | −1 on failure | | | Module being registered. |
| | | (with errno set | moduleVersion | char* | Version of the Integration |
| | | appropriately). | | | Module being registered. |
| | | | moduleId | im_t* | Returned opaque handle to |
| | | | | | the integration module to be |
| | | | | | used in subsequent API calls. |
| registerSupportInstance | Int | 0 on success or | moduleId | im_t* | Opaque handle to integration |
| | | −1 on failure | | | module returned by register |
| | | (with errno set | | | function call. |
| | | appropriately). | instanceId | char* | Identifier used for the |
| | | | | | support instance by the |
| | | | | | Systems Management |
| | | | | | Platform. |
| | | | capabilities | char* | Well-formed XML string |
| | | | | | (null-terminated) which |
| | | | | | defined the capabilities |
| | | | | | associated with this support |
| | | | | | instance. |
| registerSupportInstances | Int | 0 on success or | moduleId | im_t* | Opaque handle to integration |
| | | −1 on failure | | | module returned by register |
| | | (with errno set | | | function call. |
| | | appropriately). | instanceId[] | char*[] | Array of support instance |
| | | | | | identifiers used by the |
| | | | | | Systems Management |
| | | | | | Platform |
| dregisterSupportInstance | Int | 0 on success or | moduleId | im_t* | Opaque handle to integration |
| | | −1 on failure | | | module returned by register |
| | | (with errno set | | | function call. |
| | | appropriately). | instanceId | char* | Identifier used for the |
| | | | | | support instance by the |
| | | | | | Systems Management |
| | | | | | Platform |
| sendAlaram | Int | 0 on success or | moduleId | im_t* | Opaque handle of the |
| | | −1 on failure | | | Integration module. |
| | | (with errno set | instanceId | String | Identifier used by the |
| | | appropriately). | | | Systems Management |
| | | | | | Platform to identify the |
| | | | | | support instance. Should be |
| | | | | | the same as the ID used in |
| | | | | | registerSupportInstance. |
| | | | timestamp | Timestamp | The time that the alarm |
| | | | | | occurred as recorded by the |
| | | | | | Systems Management |
| | | | | | Platform |
| | | | Type | String | Alarm type (Systems |
| | | | | | Management Platform |
| | | | | | specific) |
| | | | severity | CIMSeverity | Severity of the alarm. |
| | | | Text | String | Alarm message text. |
| | | | data | Opaque | Arbitrary data (may be |
| | | | | | binary or ASCII or XML or |
| | | | | | null, etc.) |
| | | | encoding | String | MIME encoding type for the |
| | | | | | above data. |
| | | | length | Int | Length of the above data. |
| | | | Qos | QOS | Quality of service |
| | | | | | parameters - used if the |
| | | | | | message has to be queued at |
| | | | | | all. |
| sendEvent | Int | 0 on success or | moduleId | im_t* | Opaque handle identifying |
| | | −1 on failure | | | the Integration Module |
| | | (with errno set | | | |
| | | appropriately). | | | |
| | | | instanceId | String | Identifier used by the |
| | | | | | Systems Management |
| | | | | | Platform to identify the |
| | | | | | support instance. Should be |
| | | | | | the same as the ID used in |
| | | | | | registerSupportInstance. |
| | | | timestamp | Timestamp | The time that the alarm |
| | | | | | occurred as recorded by the |
| | | | | | Systems Management |
| | | | | | Platform. |
| | | | type | String | Event type (Systems |
| | | | | | Management Platform |
| | | | | | specific). |
| | | | eventId | String | Unique identifier for this |
| | | | | | event. |
| | | | severity | CIMSeverity | Severity of the event. |
| | | | state | EventState | State of the event (opened, |
| | | | | | closed, etc.) |
| | | | text | String | Event message text. |
| | | | data | Opaque | Arbitrary data (may be |
| | | | | | binary or ASCII or XML or |
| | | | | | null, etc.) |
| | | | encoding | String | MIME encoding type for the |
| | | | | | above data. |
| | | | length | Int | Length of the above data. |
| | | | Qos | QOS | Quality of Service |
| | | | | | parameters - used if the |
| | | | | | message has to be queued at |
| | | | | | all. |
| sendData | Int | 0 on success or | moduleId | im_t* | Opaque handle identifying |
| | | −1 on failure | | | the Integration Module. |
| | | (with errno set | instanceId | String | Systems management |
| | | appropriately). | | | Platform identifier for the |
| | | | | | support instance which is |
| | | | | | providing the data. |
| | | | type | String | Data classification type for |
| | | | | | use by interested service |
| | | | | | modules. |
| | | | suntype | String | Data subclassfication. |
| | | | data | Opaque | Arbitrary data (may be |
| | | | | | binary or ASCII or XML or |
| | | | | | null, etc.). |
| | | | encoding | String | MIME encoding type for the |
| | | | | | above data. |
| | | | length | Int | Length of the above data. |
| | | | Qos | QOS | Quality of service |
| | | | | | parameters - used if the |
| | | | | | message has to be queued at |
| | | | | | all. |

Table 2 sets forth an integrator forward API call for the Java programming language.

TABLE 2

| | | | | | |
|---|---|---|---|---|---|
| | | | | Parameter | Parameter |
| Method Name | Return Type | Return Type Description | Parameter | Type | Description |

| | | | |
|---|---|---|---|
| getProxyConnection | RSProxy | Instance of a class which | None |
| | | enables communications | |
| | | with the remote services | |
| | | proxy. | |

Once the connection class is obtained from the method shown in Table 2, the method calls as shown in Table 3 are available on this connection class.

TABLE 3

| | Return | Return Type | | | |
|---|---|---|---|---|---|
| Method Name | Type | Description | Parameter | Parameter Type | Parameter Description |
| Register | void | | moduleName | String | Name of the calling |
| | | | | | Integration Module (e.g. |
| | | | | | RasAgent IM). |
| | | | moduleVersion | String | Version of this Integration |
| | | | | | Module. |
| | | | proxyListener | RSProxyListener | Listener object for |
| | | | | | callbacks from the Proxy. |
| resgisterSupportInstance | void | | instanceId | String | Identifier used for the |
| | | | | | support instance by the |
| | | | | | Systems Management |
| | | | | | Platform. |
| | | | capabilities | String | Well-formed XML string |
| | | | | | which defined the |
| | | | | | capabilities of this support- |
| | | | | | instance. |
| registerSupportInstances | void | | instanceId[] | String[] | Array of support instance |
| | | | | | identifiers used by the |
| | | | | | Systems Management |
| | | | | | Platform. |
| registerSupportInstances | void | | instanceId | String | Identifier used for the |
| | | | | | support instance by the |
| | | | | | Systems Management |
| | | | | | Platform. |
| sendAlarm | void | | instanceId | String | Identifier used by the |
| | | | | | Systems Management |
| | | | | | Platform for the support |
| | | | | | instance reporting the |
| | | | | | alarm. Should be the same |
| | | | | | as the ID used in |
| | | | | | registerSupportInstance. |
| | | | timestamp | Timestamp | Time at which the alarm |
| | | | | | originated (in GMT!) |
| | | | type | String | Alarm type (Systems |
| | | | | | Management Platform |
| | | | | | specific). |
| | | | severity | CIMSeverity | Severity of the alarm. |
| | | | text | String | Alarm message. |
| sendAlarm | void | | instanceId | String | Identifier used by the |
| | | | | | Systems Management |
| | | | | | Platform to identify the |
| | | | | | support instance. Should |
| | | | | | be the same as the ID used |
| | | | | | in registerSupportInstance. |
| | | | timestamp | Timestamp | The time that the alarm |
| | | | | | occurred as recorded by |
| | | | | | the Systems Management |
| | | | | | Platform. |
| | | | type | String | Alarm type (Systems |
| | | | | | Management Platform |
| | | | | | specific). |
| | | | severity | CIMSeverity | Severity of the alarm. |
| | | | text | String | Alarm message text. |
| | | | data | Opaque | Arbitrary data (may be |
| | | | | | binary or ASCII or XML |
| | | | | | or null, etc.) |
| | | | encoding | String | MIME encoding type for |
| | | | | | the above data. |
| | | | length | Int | Length of the above data. |
| | | | qos | QOS | Quality of service |
| | | | | | parameters - used if the |
| | | | | | message has to be queued |
| | | | | | at all. |
| sentEvent | void | | instanceId | String | Identifier used by the |
| | | | | | Systems Management |
| | | | | | Platform for the support |
| | | | | | instance which reported the |
| | | | | | event. |
| | | | timestamp | Timestamp | The time that the event |
| | | | | | occurred as recorded by |
| | | | | | the Systems Management |
| | | | | | Platform. |
| | | | type | String | Event type (Systems |
| | | | | | Management Platform |
| | | | | | specific). |
| | | | eventId | String | Unique identifier for this |
| | | | | | event. |
| | | | severity | CIMSeverity | Severity of the event. |
| | | | state | EventState | State of the event (opened, |
| | | | | | closed, etc.) |
| | | | text | String | Event message text. |
| sendEvent | void | | instanceId | String | Identifier used by the |
| | | | | | Systems Management |
| | | | | | Platform to identify the |
| | | | | | support instance. Should |
| | | | | | be the same as the ID used |
| | | | | | in the |
| | | | | | registerSupportInstance. |
| | | | timestamp | Timestamp | The time that the alarm |
| | | | | | occurred as recorded by |
| | | | | | the Systems Management |
| | | | | | Platform. |
| | | | type | String | Event type (Systems |
| | | | | | Management Platform |
| | | | | | specific.) |
| | | | eventId | String | Unique identifier for this |
| | | | | | event. |
| | | | severity | CIMSeverity | Severity of the event. |
| | | | state | EventState | State of the event (opened, |
| | | | | | closed, etc.) |
| | | | text | String | Event message text. |
| | | | data | Opaque | Arbitrary data (may be |
| | | | | | binary or ASCII or XML |
| | | | | | or null, etc.) |
| | | | encoding | String | MIME encoding type for |
| | | | | | the above data. |
| | | | length | Int | Length of the above data. |
| | | | qos | QOS | Quality of Service |
| | | | | | parameters - used if the |
| | | | | | message has to be queued |
| | | | | | at all. |
| sendData | void | | moduleId | im_t* | Opaque handle identifying |
| | | | | | the Integration Module. |
| | | | instanceId | String | Systems management |
| | | | | | Platform identifier for the |
| | | | | | support instance which is |
| | | | | | providing the data. |
| | | | type | String | Data classification type for |
| | | | | | use by interested service |
| | | | | | modules. |
| | | | subtype | String | Data subclassification. |
| | | | data | Opaque | Arbitrary data (may be |
| | | | | | binary or ASCII or XML |
| | | | | | or null, etc.) |
| | | | encoding | String | MIME encoding type for |
| | | | | | the above data. |
| | | | length | Int | Length of the above data. |
| | | | qos | QOS | Quality of Service |
| | | | | | parameters - used if the |
| | | | | | message has to be queued |
| | | | | | at all. |

The following table shows a set of API calls which are available to the integrator 212 for back-channel communication from the remote services system 100. These calls return data to the integrator 212.

More specifically, Table 4 sets forth a set of integrator back-channel API calls for the C programming language. In the C programming language API for the back-channel, the integrator API 430 uses dynamic library/object functions to obtain the function reference and to call the function reference. To ensure that the function names do not clash with any names in use within the integrator itself 212 or the systems management platform N06 (if the integrator is running inside the systems management platform), the function names are prefixed with “RS_”.

TABLE 4

| Function Name | Return | Parameter | Parameter Type | Parameter Description |
|---|---|---|---|---|
| RS_getStatus | int | sysMgmtStatus | MgmtStatus | Pointer to structure which is populated with |
| | | | | status information on the Integration Module |
| | | | | itself, the Systems Management Platform and |
| | | | | (optionally) any support instances being |
| | | | | monitored. |
| RS_managementAction | int | instanceId | char* | Systems Management Platform support |
| | | | | instance identifier. |
| | | action | char* | XML string representing the action which |
| | | | | should be taken by the platform. The DTD for |
| | | | | this will be standard across the Integration |
| | | | | Modules for all Systems Management |
| | | | | Platforms. |
| RS_receiveUpdate | Void | instanceId | char* | Identifier of the Support Instance for which the |
| | | | | software update is intended. The special value |
| | | | | of “IntegrationModule” is reserved to indicate |
| | | | | that the software update is of the Integration |
| | | | | Module itself. In this case, the Integration |
| | | | | Module is expected (where possible) to install |
| | | | | the new software and restart itself using the |
| | | | | new software. |
| | | filename | char* | Name of the file which contains the software |
| | | | | update. |
| RS_getCapabilities | int | instanceId | char* | Systems Management Platform support |
| | | | | instance identifier. |

Table 5 sets forth a set of methods that are all declared in a RSProxyListener interface and are implemented by the integrator developer. These methods are implemented as part of the Java API.

TABLE 5

| | | | Parameter | |
|---|---|---|---|---|
| Method Name | Return Type | Parameter | Type | Parameter Description |
| getStatus | MgmtStatus | None | | |
| managmentAction | void | instanceId | String | Systems Management Platform support |
| | | | | instance identifier. |
| | | action | String | XML string representing the action which |
| | | | | should be taken by the platform. The DTD for |
| | | | | this will be standard across the Integration |
| | | | | Modules for all Systems Management |
| | | | | Platforms. |
| receiveUpdate | void | instanceId | String | Systems Management Platform support |
| | | | | instance identifier. The special value of |
| | | | | “Integration Module” is reserved to indicate |
| | | | | that the software update is of the Integration |
| | | | | Module itself. In this case, the Integration |
| | | | | Module is expected (where possible) to install |
| | | | | the new software and restart itself using the |
| | | | | new software. |
| | | filename | String | Name of the file which contains the software |
| | | | | update. |
| getCababilities | void | instanceId | String | Systems Management Platform support |
| | | | | instance identifier. |

All of the above API calls throw exceptions when they encounter errors, either in communication with the remote services proxy 210 or when processing the request.

Referring again to Figure M, the remote services proxy 210 enables multiple integrators 212 running on the same host to connect through a shared service layer to the remote services system 100. The remote services proxy 210 also provides a means by which requests from the remote services system 100 to the systems management platform N06 can be received and routed correctly. The proxy 210 is fast and lightweight by running in native code on the host.

On startup, the remote services proxy 210 consults its configuration file (persistent data) to determine whether or not the remote services proxy 210 needs to register itself with the remote services system 100.

If the remote services proxy 210 has not previously registered, the remote services proxy 210 sends a registration message to the remote services system 100 through the preconfigured communications module 214.

In session mode (i.e., there is a forward and back-channel for messages), the remote services proxy daemon M14 expects to get a positive acknowledgement of registration before the proxy daemon M14 begins full operation. Receipt of positive acknowledgement is stored in persistent data of the remote services proxy 210. Where there is no back-channel capability, however, (i.e., the system is in message mode) the remote services proxy 210 determines whether session or message mode is active through the communications layer API 440.

In session mode, the remote services proxy 210 accepts connections from integrator 212 and queues (where necessary) registration requests of the integrators 212. All other API calls which send data are accepted by the remote services proxy 210, but the data is silently dropped until such time as the positive acknowledgement to the proxy registration is received from the remote services system 100.

When the proxy 210 is expecting acknowledgement of its registration request, the acknowledgement is received in a back-channel call from the remote services proxy's heartbeat to the intermediate MLM 216. A positive acknowledgement contains default configuration information for the proxy 210. When waiting for acknowledgement, the number of heartbeats that the remote services proxy 210 waits before resending the registration request is configurable, but has a predefined default.

When starting, an integrator 212 registers itself. The integrator 212 sends a registration request containing its name and version through the integrator API 430 to the remote services proxy 210. Upon receipt of this request, the remote services proxy 210 first checks its cache (persisted to the local file-system) to determine whether the integrator 212 had previously registered with the remote services system 100. The content of the cache entry contains the remote services ID of the integrator 212. If there is an entry in the cache for the integrator 212, an opaque value is returned to the integrator 212 for the integrator 212 to identify itself in future communications with the remote services proxy 210. This value is constructed either from the remote services ID of the integrator 212 or from the name and version of the integrator 212 or a combination of the two.

The integrator 212 not appearing in the cache indicates that either the integrator 212 was never registered or that the cache configuration was deleted or lost. In this case, the remote services proxy 210 allocates a remote services ID for the integrator 212 and sends this, together with other information (e.g., module id, version) to the remote services application server 226 in a registration message.

In a deployment which uses message mode, the integrator 212 may send data as soon as the registration message has been sent. This is because there is no way for the remote services proxy 210 to know whether or not the registration was successful as there is no back-channel communications. The application server 226 drops data from unregistered proxies/integration modules and notifies the customer of any corrective action through an administration portal.

In a deployment which uses session mode, the integrator 212 is not permitted to send data to the remote services system 100 until a positive acknowledgement of the integrator's registration has been received from the remote services application server 226. Registration of support instances are queued by the proxy 210 and sent upon confirmation of registration of the integrator 212. The remote services proxy 210 rejects all other requests from the integrator 212 with an appropriate error condition.

The next stage of the registration process is for the integrator 212 to register all support instances that the integrator 212 is managing. A support instance is a device, host or software component which is being managed by the systems management platform N06 to which the integrator 212 is connected. Registration of support instances allows the remote services system 100 to perform entitlement checking against the instance and the services being provided to the customer and enables the remote services system to send data or instructions to that particular support instance to provide a particular service action.

The process of registration of a support instance is similar to the process for integrator registration. That is, the integrator 212 sends a registration request for the support instances to the remote services proxy 210. The proxy 210 checks its persistent cache to determine whether or not the support instance has previously been registered, and if not, sends a registration message to the remote services system 100. However, if the integrator 212 has not successfully registered and the remote services proxy communications are in session module, the support instance registration requests are queued on the proxy 210 and only sent when acknowledgement of the integration module registration is received.

A consideration when registering a support instance is if two different integrators 212 are registered through the same proxy 210, it is possible that the same support instance will be monitored by both systems management platforms. It is also likely in this case that both systems management platforms will have a different identifier for the support instance. It is important for the remote services system 100 to be able to determine the case when two different support instance id's refer to the same support instance for consistency (especially in monitoring). Thus, when support instance registration is performed for the second (and subsequent) integrator 212 to register through the proxy 210, the application server 226 accepts the registration, but notifies the customer through a customer portal that the customer needs to correlate (where necessary) the new support instances with those already registered. That is, link common support instances with different id's.

Support instance registration occurs dynamically during the lifetime of the integrator's 212 connection to the system management platform N06. For example, when a new agent (i.e., support instance) is added to the system management topology, the system management platform notifies the integrator 212 which then sends a registration request for that support instance. The integrator 212 only registers support instances which have an agent installed.

When a support instance is registered, the registration is cached to a local file system (as happens with the integration module registration) to save the proxy 210 from having to reregister support instances each time an integrator 212 is started. A mapping is also generated to enable the proxy 210 to route request to the support instance through the correct integrator 212. This mapping is cached (in memory) for the life of the proxy 210, but is not persistent across sessions (the mapping is recreated when an integrator 212 next registers, which happens if either the proxy 210 or the integrator 212 is restarted). The mapping of all support instances for a particular integrator 212 is cleared when the integrator 212 disconnects from the proxy 210.

To facilitate the registration of large numbers of support instances without causing massive network usage overhead, the integrator API 430 supports a call to register multiple support instances in one request. The proxy 210 handles this call by creating a single registration message including all of the support instances had not previously registered.

When the integrator 212 is notified that a support instance has been removed from the system management's topology, the integrator 212 sends a deregistration event to the remote services system 100. The deregistration event causes the support instance's id to be removed from the local (persistent) cache of the proxy 210 and is sent on to the remote services system 100, where the support instance data structure is marked as removed (or inactive) indicating that the support instance is no longer to be monitored.

The support instance data model is not removed from the database at this point because, although the support instance is no longer active, the support instance may be being reinstalled or down for maintenance. Additionally, even after being removed, it is likely that the customer will want to be able to see reports on the activity of the support instance.

When the application server 226 has marked the support instance as removed, the application server 226 sends a message to a customer administration portal asking the customer whether the support instance is to be removed permanently. If the customer acknowledges this, there is a grace period before the support instance and all of the data associated with the support instance is removed from the database. During the grace period, the customer can revoke the removal request. Additionally, once removed from the database, it may still be possible to retrieve the support instance data from an archive.

In addition to the removal message sent to the customer administration portal, an audit record is logged indicating the time and date at which the support instance was marked as removed. The audit record ensures that any issues arising from missed alarms for that support instance can be tracked.

Referring again to FIG. 14, the remote services proxy 210 uses queuing module M32 to provide persistent queuing of requests to be sent to the remote services system 100. Accordingly, in the event of a temporary network outage, or the failure of a local or remote MLM, data is not lost.

The queue of messages is managed according to the time to live (TTL) precedence and persistence attributes specified in the quality of service (QoS) parameters in the API calls by the integrator 212. Higher precedence messages are inserted toward the front of the queue and lower precedence messages toward or at the end of the queue. A new message with the same precedence as a previously queued message is queued behind the earlier message. Accordingly, correct delivery order for messages such as events, where the order could be important for correlation or aggregation purposes in the MLM is maintained. Queue persistence is implemented using the file system of the remote services proxy host.

The proxy 210 tracks the sizes of all queued messages and limits the total size of the queue according to a configuration parameter. When the queue reaches its upper limit, the queue is managed according to the following queue management method (until enough space is freed for the new message).

The proxy 210 first locates the oldest message whose TTL has expired and discards this message. Next, the proxy 210 locates the oldest message whose precedence is bulk and whose persistence is set to normal, and discards this message. Next the proxy 210 determines whether the new message's precedence is bulk and discards this message. If the new message's precedence is urgent, then the proxy 210 locates the oldest message whose precedence is normal and whose persistence is normal and discards this message. Finally, if none of these criteria are met, then the proxy 210 rejects the new message.

The rejection of an incoming message has consequences which may impact service delivery, accordingly, this rejection is considered an error condition by the proxy 210 (perhaps indicating that an MLM has failed or been moved without the proxy configuration being updated.) The proxy 210 uses separate size limits for each message priority as well as aggregated limits. Where separate size limits are used, the queue management method is modified accordingly.

The proxy 210 also supports data throttle using the queuing module 1432. The throttle control includes a plurality of throttle parameters including the maximum number of bytes per time period (e.g., hour/day), the maximum number of bytes per message, and the maximum number of messages per time period. The throttle control provides a manual start stop interface to allow system administration control over when data can be sent. Any or all of the throttle parameters may be set to unlimited, which is the default configuration.

All messages passing through the remote services proxy 210 to the MLMs include a unique remote services identification number in the message header. The identification number is used by the remote services system 100 both in acknowledgement packets and for marshaling of specific operations (such as request to send bulk data).

All packets received on the back-channel by the proxy 210 include a destination designator, which is the remote services ID of the intended recipient. This destination information is looked up in the proxy's map of integrator 212 so that the packet can be forwarded to the appropriate module.

The proxy 210 may also be the recipient of data from the remote services system 100. Thus, the proxy 210 includes a specific integrator 212 to handle data intended for the proxy 210. A destination designator is used to address the proxy's own integrator 212 to allow for consistent treatment of modules by the proxy 210.

There are a plurality of routing exceptions with which the proxy routing handler deals. These routing exceptions include when the destination field with a remote services ID is not known to the proxy 210 and when the destination field with a remote services ID is known to the proxy 210 but is offline.

The destination field being unknown to the proxy 210 indicates that the message is effectively a misrouted message. The misrouted message is discarded by the proxy 210 and a notification message is sent back to the remote services system 100 so indicating.

The destination field being offline indicates that the message was correctly routed. However, the integrator 212 which is the destination is disconnected from the proxy 210 for some reason. The message is queued in a simple queue and delivered when the integrator 212 next connects. Configuration parameters for the proxy 210 indicate the amount of time such a message should be queued before being discarded. If the message is discarded, then a message is sent back to the remote services system 100 so indicating.

Data received on the back-channel for routing is run through an XML parser on receipt for a check on well-formattedness of the XML. This check relieves the load on the integrator 212 by providing the integrator 212 with well-formed XML.

The majority of the data forwarded by the proxy 210 is in small packets (e.g., a few Kbytes) in response to events in the system management platform. However, there are services which require the transfer of bulk data which may have significant size.

The impact of transferring multi-megabyte files through the MLMs could impact the ability of the infrastructure 102 to deliver more time critical information. Thus, the method of transferring bulk data from the proxy 210 is slightly different to the method for transferring smaller packets.

More specifically, when transferring bulk data, the proxy 210 first sends a small request packet to the remote services system 100 containing information such as the type of the data (for determining the services module(s) which are interested) and the amount of data. The remote services system 100 responds with a packet containing the identification number of the original request and a URL to which the data should be directed. This URL could be on the intermediate MLM 216. Upon receiving this information, the proxy 210 initiates a new connection to the specified URL and begins transferring the data.

The status returned by the MLM in response to a request for bulk transfer of data is okay, deferred or rejected. With an okay status, the request is accepted and the proxy 210 now sends the data. The content of the acknowledgement message also includes a URL to which the data is to be sent.

With a deferred status, the request is deferred because the MLM or application server 226 is unable to process the request at this time. The reason for the deferral is detailed in the deferral response. In the case of a deferral, the proxy 210 re-queues the bulk transfer request so that the request is sent with the next heartbeat to the MLM. The proxy 210 logs all deferred requests. The number of times that the proxy 210 attempts to send data before aborting the transfer is configurable. If the transfer is aborted, this information is logged along with the details of the message and the reason for the deferral and the message is discarded.

With a rejected status, the request is rejected by the MLM or application server 226. The proxy 210 removes the bulk data message from its queue and logs that the request was rejected. The rejection message contains a code indicating the reason that the request was rejected. This reason is recorded by the proxy 210.

Similarly, in response to the actual bulk data transfer, the recipient sends a message with the status of the transfer. The status may be okay or rejected. An okay status indicates that the transfer was successful. A rejected status indicates that the bulk data transfer failed. The rejected message contains an error indicator which is logged by the proxy 210.

For availability purposes, the proxy 210 sends a status heartbeat back to the remote services system 100 at regular periods. The period depends on the deployment model and the communications module in use. The period is configurable. Where the communications module M28 allows for back-channel communications, the proxy 210 may receive a back-channel request when sending out the status heartbeat message. The proxy 210 makes a regular callback on the back-channel of the integrator API 430 to each of the integrators 212 which have registered with the proxy 210. This callback requests the status of the integrator 212, the status of the system management platform and optionally the status of each support instance. Once the status has been gathered for all active integrators 212, the proxy 210 adds its own status and sends the entire status as a message back to the remote services system 100.

In the remote services system 100, remote access to customer systems is initiated by the customer, thus ensuring that the customer has control of when and how a support engineer is able to access the customer's systems. The remote access application communicates with the application servers 226 to initiate a session.

A remote access integration module is provided which allows a connection from the remote access application to the proxy 210 for the purpose of establishing the remote access session. The remote access integration module makes a call to the remote services system 100 requesting the remote access session and upon success, passes the connection parameters back to the remote access applications so that the application can establish the link. The communication link may rely on the HTTP proxy running on the intermediate MLM 216 to establish connectivity back to the application servers 226.

It may be necessary for the remote services system 100 to request data from an integrator 212. The integrator API 430 supports this via a managmentAction call. This back-channel API call takes, as parameters, the ID of the integration module or support instance to which the request is to be routed and an XML format string which includes a unique identifier, the request name and any parameters needed. Data to be sent in response to this request is sent on the forward channel (via e.g., the sendData API call) and includes the request identifier to enable a service module 102 or application server 226 to correlate the response with the original pull request.

Occasionally updates from the infrastructure 102 are handled by the proxy 210. Updates handled by the proxy 210 include updates to the proxy itself, updates to an integrator 212, new or updated system management modules and proxy configuration changes. Automatically updating software is often undesirable for many customers without first being able to inspect or be advised of an update. Accordingly installation of any of the updates proceeds upon confirmation by the customer via an administration portal.

When the proxy 210 receives a software update for itself, the proxy 210 saves a copy of its present instantiation and then copies the new software into the place of the original. The proxy 210 then exits to allow the watchdog to restart the proxy 210. Accordingly, if the proxy update fails or is accidentally killed, the original proxy can be restarted.

Because the integrator 212 may be a component of the systems management platform N06, it may be difficult to update this integrator automatically unless provided for by the systems management vendor. Each integration module includes a capability which determines whether or not the integration module can be updated automatically. If this capability is defined, this functionality is provided for in the integration module's API. The integration module itself then receives the notification of the update via the API and is responsible for locating, installing and starting the update. When an integration module cannot be updated automatically, the customer is notified of the update via an administration portal and is provided instructions (or a script) to perform the update manually.

Not all systems management platforms N06 support loading of modules into an agent layer, and even those that do may not support the loading programmatically. The systems management platforms N06 that do support programmatic loading of modules provide an implementation for the appropriate API call in the integrator API 430. The proxy 210 may then call this API when a new module is to be loaded. To save passing large volumes of data through the API, a file name (or URL) may be passed to the integrator 212. The integrator 212 is then responsible for loading and processing the update. Where the systems management platform N06 does not support programmatic loading of modules, the customer is advised of a new module (or update) via the administration portal and is provided instructions (or a script) via which the module can be manually added.

Occasionally, the configuration of the proxy 210 itself may be updated. The update may be as a result of a change of communications (e.g., encrypted vs. not encrypted) or to allow new queuing or throttle thresholds to be set. The proxy 210 receives the configuration changes and applies them to its persistent configuration files before reconfiguring itself with the new parameters.

The remote services proxy 210 has two primary functions, to receive and forward messages from integrator 212 and to receive and forward back-channel messages. The functions overlap. More specifically, when a message is received from an integrator 212, the message is placed in the proxy's outbound queue for sending. This allows the receiver to rapidly turn around processing of the incoming data from the integrator 212 without having to wait to send and get a response to the message. Accordingly, the proxy 210 uses two threads: a receive and queue message from integrator 212 thread and a send queued messages and receive back-channel messages thread.

The send queued messages thread creates temporary threads as necessary to forward back-channel requests to the integrator 212. The maximum number of temporary threads simultaneously running is a configurable parameter. In one embodiment, the default number of threads is five threads. A temporary thread is not used in deployments which use Email as the transport protocol.

In addition to the two threads discussed, a periodic temporary thread is created from the mean thread of the proxy 210. The periodic thread is responsible for gathering status information from the integrator 212, incorporating its own status and then queuing this message as its heartbeat to the MLM. Also, when a bulk data transfer is to be performed, a temporary thread is created to send the data. This temporary thread is because there may be a lot of data to send over a relatively slow connection and it is not desirable to block the sending of an urgent alarm when sending this data.

The remote services system 100 may include built-in redundancy to ensure continuity of management even in the event of the failure of the primary management server or agent. The remote services system 100 operates and integrates with such redundant systems seamlessly.

Integration with such redundant systems is via multiple integrators 212, each attached to a different proxy 210. Thus, a redundant communication channel is created that feeds the application servers 226. The application servers 226 then remove duplicated messages. When deploying such a system, the customer first deploys a first proxy 210 and an integration module linking the proxy to one of the redundant agents or system management platforms. Then, the customer creates a second proxy 210 and declares the second proxy 210 as a redundant instance of the existing proxy 210.

When the second proxy is defined in the data model, the second proxy is installed by the customer using the correct configuration. When the secondary proxy is installed and connected to the remote service system 100, the customer can install the integration module and link the integration module to the redundant instance of the agent or system management platform.

Support instances are registered independently by each integrator 212. However, the application server 226 makes the match between the two remote service IDs based on the external ID used by the system management platform or agent to identify the support instance. This matching enables the application server 226 to remove duplicate messages coming from the same support instance via the redundant channels.

The support instance may exist only on one proxy if a failure happened while the second system was registering the failure. A coherency check tool is provided within the application server 226 to identify such a failure.

With a redundant scheme, during forward data flow messages from the two redundant system management platforms 1506 flow through the remote services system 100 using two different paths. If one system management platform fails, the other continues to feed the remote services system 100. No state of the system management platform is needed within the remote service system. The filtering of the duplicate messages is via the application server 226.

The back-channel of messages for support instances reached through redundant proxies is dynamic. To choose which proxy to use, the application server uses the proxy from which it received the first message from the particular support instance.

Other Embodiments

Other embodiments are within the following claims.

What is claimed is:

1. An apparatus for interfacing between a systems management system and a remote services system comprising:
a systems management application program interface;
a systems management integrator application program interface, the systems management integrator application program interface providing a normalization point where data from the systems management system is normalized to a remote services system standard; and
an integrator coupled between the systems management application program interface and the systems management integrator application program interface, the integrator collecting and detecting information from the systems management system.

2. The apparatus of claim 1 wherein the systems management integrator application program interface includes:
a forward calls component, the forward calls component providing forwards calls from the systems management system to the remote services system.

3. The apparatus of claim 2 wherein the systems management integrator application program interface includes:
a back-channel calls component, the back-channel calls component providing back-channel calls from the remote services system to the system management system.

4. The apparatus of claim 1 wherein the systems management integrator application program interface provides generic message interfaces as well as specific message interfaces, the specific message interfaces being provided to enable the remote services system to handle a message without having to inspect the contents of the message.

5. The apparatus of claim 4 wherein the specific message interfaces include an alarm message.

6. The apparatus of claim 4 wherein the specific message interfaces include an event message.

7. The apparatus of claim 4 wherein:
the generic message interfaces includes data, the data including a class, and
the integrator sets the class of the data.

8. The apparatus of claim 3 wherein the systems management integrator application program interface:
provides support for declaring capabilities of a support instance at registration time via the forward channel, and
provides support for a request of the capabilities of the support instance via the back-channel after registration time.

9. The apparatus of claim 1 wherein the systems management integrator application program interface provides an interface between the integrator and a remote services infrastructure.

10. The apparatus of claim 8 wherein the systems management integrator application program interface is coupled to a remote services proxy of the remote services infrastructure.

11. A systems management integrator application program interface for a remote services system comprising:
a forward calls component, the forward calls component providing forwards calls from a systems management system to the remote services system; and
a back-channel calls component, the back-channel calls component providing back-channel calls from the remote services system to the system management system.

12. The systems management integrator application program interface of claim 11 wherein the systems management integrator application program interface provides generic message interfaces as well as specific message interfaces, the specific message interfaces being provided to enable the remote services system to handle a message without having to inspect the contents of the message.

13. The systems management integrator application program interface of claim 12 wherein the specific message interfaces include an alarm message.

14. The systems management integrator application program interface of claim 12 wherein the specific message interfaces include an event message.

15. The systems management integrator application program interface of claim 12 wherein
the generic message interfaces includes data, the data including a class, and
an integrator sets the class of the data.

16. The systems management integrator application program interface of claim 11 wherein the systems management integrator application program interface
provides support for declaring capabilities of a support instance at registration time via the forward channel, and
provides support for a request of the capabilities of the support instance via the back-channel after registration time.

17. The systems management integrator application program interface of claim 11 wherein the systems management integrator application program interface provides an interface between a systems management platform and a remote services infrastructure.

18. The systems management integrator application program interface of claim 17 wherein the systems management integrator application program interface is coupled to a remote services proxy of the remote services infrastructure.

19. A method for interfacing between a systems management system and a remote services system comprising:
providing a systems management application program interface;
collecting and detecting information from the systems management system using a systems management integrator, the systems management integrator interfacing with the systems management system via the systems management application program interface;
providing and receiving information to the remote services system, the providing and receiving information being via a systems management integrator application program interface, the systems management integrator application program interface providing a normalization point where data from the systems management system is normalized to a remote services system standard.
